(19) United States
(12) Patent Application Publication
(10) Pub. No.: US 2026/0189772 A1
(43) Pub. Date: Jul. 2, 2026

(54) SELECTIVE UNICAST REQUESTS FOR BROADCAST AND MULTICAST DELIVERY OF MEDIA DATA

(71) Applicant: QUALCOMM Incorporated, San Diego, CA (US)

(72) Inventors: Thomas Stockhammer, Bergen (DE); Imed Bouazizi, Celina, TX (US); Aytac Biber, Carlsbad, CA (US)

(21) Appl. No.: 19/413,486

(22) Filed: Dec. 9, 2025

Related U.S. Application Data
(60) Provisional application No. 63/741,290, filed on Jan. 2, 2025.

(51) Int. Cl. H04N 21/854; H04N 21/239; H04N 21/254; H04N 21/2665; H04N 21/8358

(52) U.S. Cl. CPC H04N 21/854; H04N 21/2393; H04N 21/254; H04N 21/2665; H04N 21/8358

(57) ABSTRACT

An example server unit for retrieving media data on behalf of a client device, the server unit comprising: a memory configured to store media data; and a processing system implemented in circuitry and configured to: receive, for the client device, configuration data for a media streaming session for a media presentation to be received via broadcast or unicast, the configuration data indicating that personalization data for the media presentation can be selectively exchanged using a unicast transmission; determine that at least a portion of the personalization data is to be exchanged; and exchange the at least portion of the personalization data via a unicast transmission. The server unit may be a server device separate from the client device or a proxy server included in a middleware unit of the client device.

This application claims the benefit of U.S. Provisional Application No. 63/741,290, filed Jan. 2, 2025, the entire contents of which are hereby incorporated by reference.

### TECHNICAL FIELD

This disclosure relates to transport of media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for transporting media data using both a broadcast or multicast service and a unicast service. For example, initially, a content provider may stream media data to one or more local servers using broadcast or multicast. A client device may then retrieve the media data from at least one of the local servers using unicast requests (e.g., HTTP requests). Many streaming services provide personalized data, such as targeted advertisement data and/or watermarked media data. In the case of broadcast and multicast, it is assumed that a network destination receives the same media data, which renders personalization difficult. Thus, this disclosure describes techniques by which broadcast and multicast data can be personalized, e.g., through unicast requests for personalized media data. Such unicast requests may be performed by the local servers or by the client device.

In one example, a method of retrieving media data includes: receiving, by a server unit for a client device, configuration data for a media streaming session for a media presentation to be received via broadcast or unicast, the configuration data indicating that personalization data for the media presentation can be selectively exchanged using a unicast transmission; determining, by the server unit, that at least a portion of the personalization data is to be exchanged; and exchanging, by the server unit, the at least portion of the personalization data via a unicast transmission.

In another example, a server unit for retrieving media data on behalf of a client device includes: a memory configured to store media data; and a processing system implemented in circuitry and configured to: receive, for the client device, configuration data for a media streaming session for a media presentation to be received via broadcast or unicast, the configuration data indicating that personalization data for the media presentation can be selectively exchanged using a unicast transmission; determine that at least a portion of the personalization data is to be exchanged; and exchange the at least portion of the personalization data via a unicast transmission.

In another example, a method of retrieving media data includes: receiving, by a client device, a manifest file for a media presentation, the manifest file including a first set of data representing a first network location for retrieving main media content of the media presentation and a second set of data representing a second, different network location for retrieving personalization data for the media presentation, the first network location corresponding to a server device; requesting, by the client device, at least one segment of the main media content from the server device; requesting, by the client device, at least a portion of the personalization data from the second network location; and combining, by the client device, the at least one segment of the main media content with the at least portion of the personalization data.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating an example set of components of a retrieval unit.

FIG. 3 is a conceptual diagram illustrating elements of example multimedia content.

FIG. 4 is a block diagram illustrating elements of an example video file, which may correspond to a segment of a representation.

FIG. 5 is a block diagram illustrating an example distribution network (DN) and a user equipment (UE) device that may perform the techniques of this disclosure.

FIG. 6 is a block diagram illustrating an example set of devices that may perform hybrid transmission services.

FIG. 7 is a flow diagram illustrating an example of unicast repairs to media streamed via broadcast/multicast.

FIG. 8 is a block diagram illustrating a basic architecture and function of a system that may perform the techniques of this disclosure.

FIG. 9 is a call flow diagram illustrating an example process of sending common media client data (CMCD) as personalization data when main media content is initially sent via broadcast or multicast per techniques of this disclosure.

FIG. 10 is a block diagram illustrating an example system that may be adapted to send and receive CMCD data per techniques of this disclosure.

FIG. 11 is a block diagram illustrating an example system for exchanging watermarked data per techniques of this disclosure.

FIG. 12 is a flow diagram illustrating an example watermarking process.

FIG. 13 is a conceptual diagram illustrating an example set of watermark pace information (WMPaceInfo).

FIG. 14 is a conceptual diagram illustrating examples of a sidecar approach to providing A and B variants of watermarked segments in a manifest file per techniques of this disclosure.

FIG. 15 is a conceptual diagram illustrating an example of WMPaceInfo in live workflows.

FIG. 16 is a conceptual diagram illustrating an example watermarked naming pattern and an example non-watermarked naming pattern.

FIG. 17 is a conceptual diagram illustrating an example architecture for sending watermarked media data.

FIG. 18 is a block diagram illustrating an example architecture for integrating watermarking into multicast/broadcast per techniques of this disclosure.

FIG. 19 is a block diagram illustrating an example architecture for performing the techniques of this disclosure.

FIG. 20 is a flowchart illustrating an example method of retrieving media data by a server unit on behalf of a client device per techniques of this disclosure.

FIG. 21 is a flowchart illustrating an example method of retrieving media data by a client device per techniques of this disclosure.

### DETAILED DESCRIPTION

In general, this disclosure describes techniques for personalizing media data that is initially transmitted via broadcast or multicast to a local server device, then requested from the local server device by a client device. Personalization of the media data may include, for example, requesting targeted advertisements that are relevant to a user of the client device, skipping advertisements for certain users, providing license keys to access certain media data, watermarked data, or the like. Because all media data streamed using broadcast or multicast is the same, this disclosure describes techniques by which broadcast or multicast media data can be personalized using unicast requests for personalized data, such as by the local server device or by the client device. In this manner, even in the case of media data being broadcast or multicast, the media data can be personalized. As such, these techniques may improve the performance of the local server device, the broadcast or multicast server, and the client device, because these devices may engage in a broadcast or multicast transmission of the media data while still personalizing the media data, thereby avoiding an entirely unicast transmission for all of the media data and the personalization data.

Other examples of personalization include ad tracking and beaconing, where unicast requests can send user-specific tracking information back to an ad server. In other examples, unicast requests may be used to retrieve Digital Rights Management (DRM) license keys that are unique to a particular user or device, enabling access to protected content that was delivered via a general broadcast. Furthermore, the personalization data may include monetization incentives, such as enabling ad-skipping for premium users, or providing targeted dynamic ad content based on identifiers supplied by client-side ad decision systems.

In some examples, a multicast/broadcast (MC/BC) client, which may be a gateway server or a local proxy server on a user equipment or other such server unit, handles the unicast requests. A media client (such as a DASH or HLS client) may send conditioned requests to the MC/BC client. The MC/BC client may serve the requested resource from the broadcast distribution, or may process additional information in the request to selectively issue a unicast request for personalization data. For example, the MC/BC client may collect common media client data (CMCD) from the client request and provide aggregated CMCD data to a network function. In some examples, such as for A/B watermarking, one media variant may be distributed over broadcast, and the MC/BC client may use a watermark token to determine whether to serve the broadcast variant or to selectively request a different variant from a unicast server.

The techniques of this disclosure also provide for alternatives to optimize unicast traffic. For instance, rather than requesting an entire personalized segment via unicast, the MC/BC client may request only a specific byte range of the segment that contains the differentiating data, such as a watermark. The MC/BC client may then replace that portion of the broadcast-received segment with the unicast-received byte range. The configuration for the MC/BC client may also be used to minimize unicast traffic, such as by biasing the selection of non-broadcast variants to occur less frequently or by applying a filter to determine when to issue unicast requests. These techniques may thereby improve the personalization of media data while still leveraging the efficiency of broadcast or multicast transmission.

The techniques of this disclosure may be applied to video files conforming to video data encapsulated according to any of ISO base media file format, Scalable Video Coding (SVC) file format, Advanced Video Coding (AVC) file format, Third Generation Partnership Project (3GPP) file format, and/or Multiview Video Coding (MVC) file format, or other similar video file formats.

In HTTP streaming, such as Dynamic Adaptive Streaming over HTTP (DASH) and HTTP Live Streaming (HLS), frequently used operations include HEAD, GET, and partial GET. The HEAD operation retrieves a header of a file associated with a given uniform resource locator (URL) or uniform resource name (URN), without retrieving a payload associated with the URL or URN. The GET operation retrieves a whole file associated with a given URL or URN. The partial GET operation receives a byte range as an input parameter and retrieves a continuous number of bytes of a file, where the number of bytes correspond to the received byte range. Thus, movie fragments may be provided for HTTP streaming, because a partial GET operation can get one or more individual movie fragments. In a movie fragment, there can be several track fragments of different tracks. In HTTP streaming, a media presentation may be a structured collection of data that is accessible to the client. The client may request and download media data information to present a streaming service to a user.

In the example of streaming 3GPP data using HTTP streaming, there may be multiple representations for video and/or audio data of multimedia content. As explained below, different representations may correspond to different coding characteristics (e.g., different profiles or levels of a video coding standard), different coding standards or extensions of coding standards (such as multiview and/or scalable extensions), or different bitrates. The manifest of such representations may be defined in a Media Presentation Description (MPD) data structure. A media presentation may correspond to a structured collection of data that is accessible to an HTTP streaming client device. The HTTP streaming client device may request and download media data information to present a streaming service to a user of the client device. A media presentation may be described in the MPD data structure, which may include updates of the MPD.

A media presentation may contain a sequence of one or more Periods. Each period may extend until the start of the next Period, or until the end of the media presentation, in the case of the last period. Each period may contain one or more representations for the same media content. A representation may be one of a number of alternative encoded versions of audio, video, timed text, or other such data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

In general, this disclosure describes techniques for personalizing media data that is initially transmitted via broadcast or multicast to a local server device, then requested from the local server device by a client device. Personalization of the media data may include, for example, requesting targeted advertisements that are relevant to a user of the client device, providing license keys to access certain media data, reporting Common Media Client Data (CMCD), or providing specific media variants for A/B watermarking.

Media distribution using broadcast or multicast, such as 5G Broadcast or Multicast/Broadcast Service (MBS), may efficiently deliver a common stream of media data to multiple receivers. Because all media data streamed using broadcast or multicast is the same, this distribution model may present challenges for personalization, which relies on customized requests and responses for a specific client. For example, client metadata included in a request for a broadcast resource may terminate at a local media server and fail to reach a network application server, preventing functions like CMCD reporting or dynamic ad insertion.

The techniques of this disclosure may enable robust personalization through the use of a server unit to manage the data requests. This server unit, which may be an on-device proxy server or a gateway Multicast/Broadcast (MC/BC) client, or other such unit, may receive configuration data indicating that personalization data can be selectively exchanged using a unicast transmission. The server unit may receive the main media content via the broadcast or multicast transmission. The server unit may also receive a request from a media player (e.g., a DASH or HLS client) that includes data representing personalization, such as a CMCD token or a watermark token.

Based on the configuration and the personalization data, the server unit may determine that a personalization exchange is needed. The server unit may process the request and selectively exchange the personalization data via a unicast transmission, while serving the main media content from the broadcast. For instance, the server unit may aggregate CMCD data from multiple client requests and send a unicast report to a network function. In another example, the server unit may receive a primary media variant via broadcast and, based on a client's watermark token, issue a selective unicast request to retrieve a secondary media variant. These techniques may thus provide robust personalization while avoiding an entirely unicast transmission for all media data, thereby improving device performance and optimizing unicast traffic.

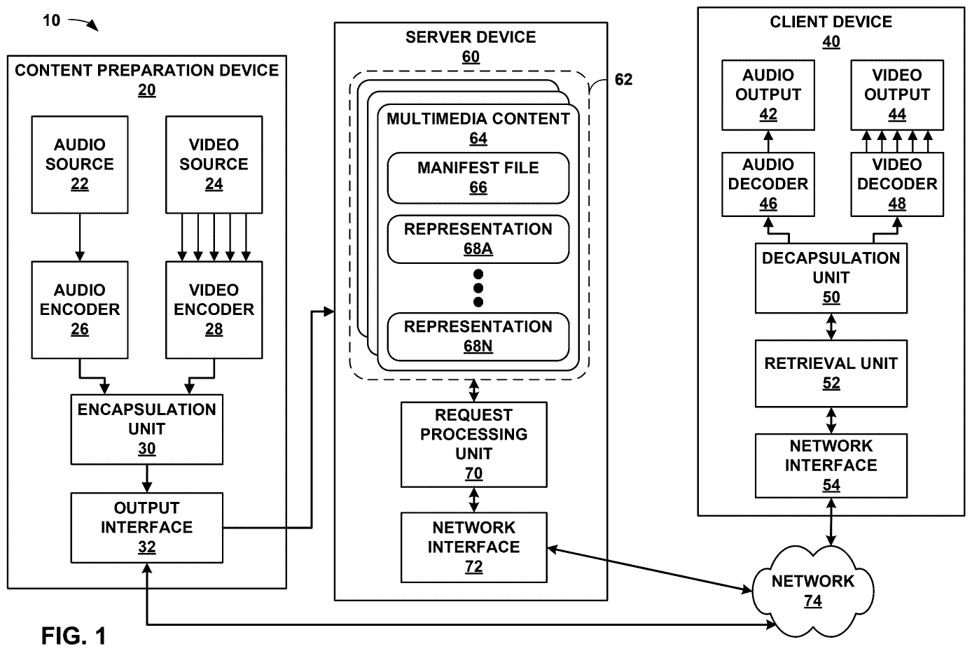

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

Many video coding standards, such as ITU-T H.264/AVC and the upcoming High Efficiency Video Coding (HEVC) standard, define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of macroblocks that need to be processed, decoded picture buffer (DPB) size, coded picture buffer (CPB) size, vertical motion vector range, maximum number of motion vectors per two consecutive MBs, and whether a B-block can have sub-macroblock partitions less than 8×8 pixels. In this manner, a decoder may determine whether the decoder is capable of properly decoding the bitstream.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points. In addition, encapsulation unit 30 may form a manifest file, such as a media presentation descriptor (MPD) that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1, server device 60 includes storage medium 62 that stores various multimedia contents 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. For example, request processing unit 70 may implement hypertext transfer protocol (HTTP) version 1.1, as described in RFC 2616, “Hypertext Transfer Protocol-HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally or alternatively, request processing unit 70 may be configured to deliver media data via a broadcast or multicast protocol, such as eMBMS. Content preparation device 20 may create DASH segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

As illustrated in the example of FIG. 1, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bitrate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60. Likewise, server device 60 may transmit main media content, such as a first media variant (e.g., Variant A) of watermarked data, using a broadcast or multicast (BC/MC) distribution via network 74. Client device 40 may receive this data via BC/MC distribution.

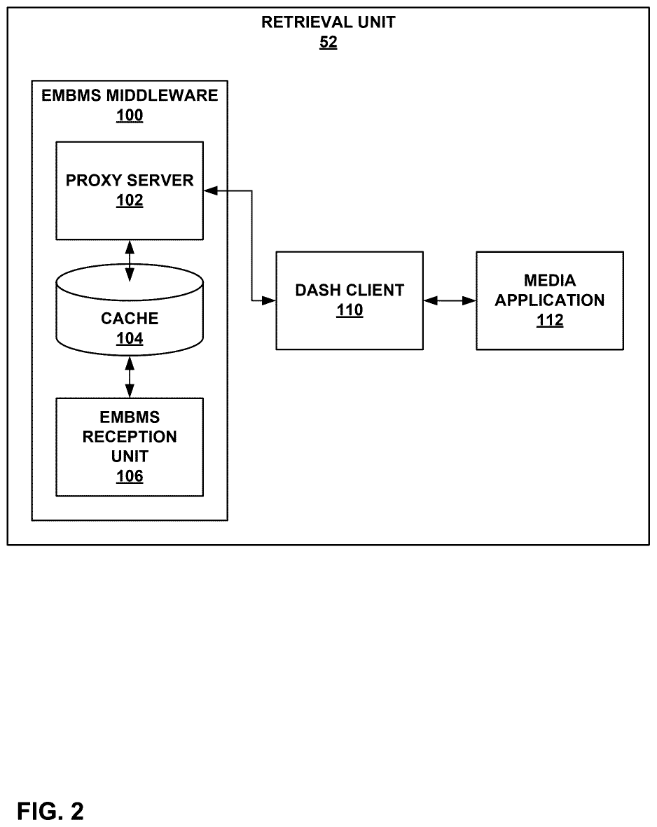

In some examples, retrieval unit 52 of client device 40 may be configured to include the functionality of a server unit, such as a proxy server or MC/BC client (e.g., eMBMS middleware unit 100 shown in FIG. 2). This server unit receives configuration data, which may be included in manifest file 66, indicating that personalization data is available via unicast. Alternatively, the server unit may form part of network 74, separate from client device 40. When a media player of client device 40 (e.g., DASH client 110 of FIG. 2) issues a request for media data, the request may include personalization data, such as a Common Media Client Data (CMCD) token or a watermark token.

Retrieval unit 52 (which may act as the server unit) may determine that the personalization data is to be exchanged. Based on the configuration data and the token, retrieval unit 52 may selectively issue a unicast request via network 74 to retrieve the personalization data, such as a second media variant (e.g., Variant B) or a specific byte range of the second media variant. This selective unicast request may be directed to server device 60. Request processing unit 70 may then service the request. Retrieval unit 52 may then provide the appropriate media data (either the broadcast content or the personalized unicast content) to the media player for decoding and presentation by decapsulation unit 50, audio decoder 46, and video decoder 48.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via retrieval unit 52. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

FIG. 2 is a block diagram illustrating an example set of components of retrieval unit 52 of FIG. 1 in greater detail. In this example, retrieval unit 52 includes eMBMS middleware unit 100, DASH client 110, and media application 112.

In this example, eMBMS middleware unit 100 further includes eMBMS reception unit 106, cache 104, and proxy server unit 102. In this example, eMBMS reception unit 106 is configured to receive data via eMBMS, e.g., according to File Delivery over Unidirectional Transport (FLUTE), described in T. Paila et al., “FLUTE-File Delivery over Unidirectional Transport,” Network Working Group, RFC 6726 November 2012, available at tools.ietf.org/html/rfc6726. That is, eMBMS reception unit 106 may receive files via broadcast from, e.g., server device 60, which may act as a broadcast/multicast service center (BM-SC).

As eMBMS middleware unit 100 receives data for files, eMBMS middleware unit may store the received data in cache 104. Cache 104 may comprise a computer-readable storage medium, such as flash memory, a hard disk, RAM, or any other suitable storage medium.

Proxy server unit 102 may act as a server for DASH client 110. For example, proxy server unit 102 may provide a MPD file or other manifest file to DASH client 110. Proxy server unit 102 may advertise availability times for segments in the MPD file, as well as hyperlinks from which the segments can be retrieved. These hyperlinks may include a localhost address prefix corresponding to client device 40 (e.g., 127.0.0.1 for IPV4). In this manner, DASH client 110 may request segments from proxy server unit 102 using HTTP GET or partial GET requests. For example, for a segment available from link http://127.0.0.1/rep1/seg3, DASH client 110 may construct an HTTP GET request that includes a request for http://127.0.0.1/rep1/seg3, and submit the request to proxy server unit 102. Proxy server unit 102 may retrieve requested data from cache 104 and provide the data to DASH client 110 in response to such requests.

In operation, DASH client 110 may send conditioned requests for media data to proxy server unit 102. These requests may include additional information provided with the request, such as personalization data (e.g., Common Media Client Data (CMCD) or a watermark token). Proxy server unit 102 may execute a request and response function to process this additional information and determine that personalization data is to be exchanged. Based on the configuration data and the personalization data, proxy server unit 102 may determine whether to serve the requested media resource from the broadcast distribution (e.g., by retrieving the data from cache 104) or to selectively issue a new unicast request (e.g., an HTTP GET or partial GET request) to retrieve the personalization data from a network server. In some examples, the requested resource may be served by a combination, such as by retrieving a byte range via unicast and combining the byte range with data from cache 104. Proxy server unit 102 may provide the appropriate main media content and personalization data to DASH client 110.

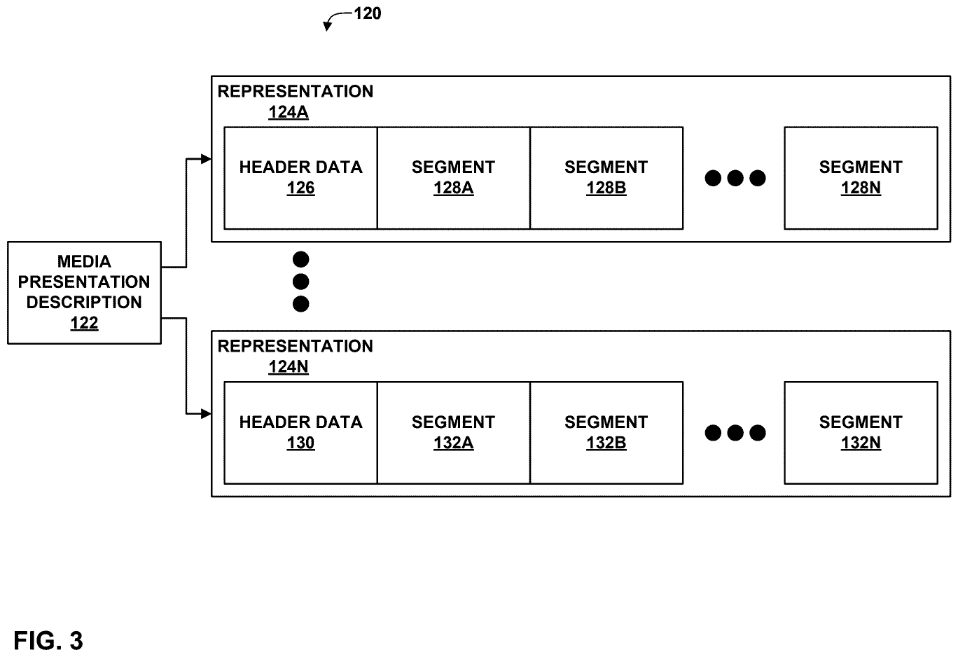

FIG. 3 is a conceptual diagram illustrating elements of example multimedia content 120. Multimedia content 120 may correspond to multimedia content 64 (FIG. 1), or another multimedia content stored in storage medium 62. In the example of FIG. 3, multimedia content 120 includes media presentation description (MPD) 122 and a plurality of representations 124A-124N (representations 124). Representation 124A includes optional header data 126 and segments 128A-128N (segments 128), while representation 124N includes optional header data 130 and segments 132A-132N (segments 132). The letter N is used to designate the last movie fragment in each of representations 124 as a matter of convenience. In some examples, there may be different numbers of movie fragments between representations 124.

MPD 122 may comprise a data structure separate from representations 124. MPD 122 may correspond to manifest file 66 of FIG. 1. Likewise, representations 124 may correspond to representations 68 of FIG. 1. In general, MPD 122 may include data that generally describes characteristics of representations 124, such as coding and rendering characteristics, adaptation sets, a profile to which MPD 122 corresponds, text type information, camera angle information, rating information, trick mode information (e.g., information indicative of representations that include temporal sub-sequences), and/or information for retrieving remote periods (e.g., for targeted advertisement insertion into media content during playback).

Header data 126, when present, may describe characteristics of segments 128, e.g., temporal locations of random access points (RAPs, also referred to as stream access points (SAPs)), which of segments 128 includes random access points, byte offsets to random access points within segments 128, uniform resource locators (URLs) of segments 128, or other aspects of segments 128. Header data 130, when present, may describe similar characteristics for segments 132. Additionally or alternatively, such characteristics may be fully included within MPD 122.

Segments 128, 132 include one or more coded video samples, each of which may include frames or slices of video data. Each of the coded video samples of segments 128 may have similar characteristics, e.g., height, width, and bandwidth requirements. Such characteristics may be described by data of MPD 122, though such data is not illustrated in the example of FIG. 3. MPD 122 may include characteristics as described by the 3GPP Specification, with the addition of any or all of the signaled information described in this disclosure.

Each of segments 128, 132 may be associated with a unique uniform resource locator (URL). Thus, each of segments 128, 132 may be independently retrievable using a streaming network protocol, such as DASH. In this manner, a destination device, such as client device 40, may use an HTTP GET request to retrieve segments 128 or 132. In some examples, client device 40 may use HTTP partial GET requests to retrieve specific byte ranges of segments 128 or 132.

In accordance with the techniques of this disclosure, media data for a media presentation may include both broadcast or multicast main media content and personalization media data, such as targeted advertisements, watermarked data, or the like. MPD 122 may include data indicating how to access both the main media content and the personalization media data. For example, MPD 122 may include data for discriminating between requests to a local media server (e.g., server device 60 of FIG. 1 or proxy server unit 102 of FIG. 2) and unicast requests (e.g., to content preparation device 20 or a separate personalization media data server, such as an advertisement server, watermarked data server, or the like). MPD 122 may include data representing different service locations, which may have different URLs. For example, main media data received by server device 60 via broadcast or multicast from content preparation device 20 may have a first base URL, and personalization media data may have a second, different base URL.

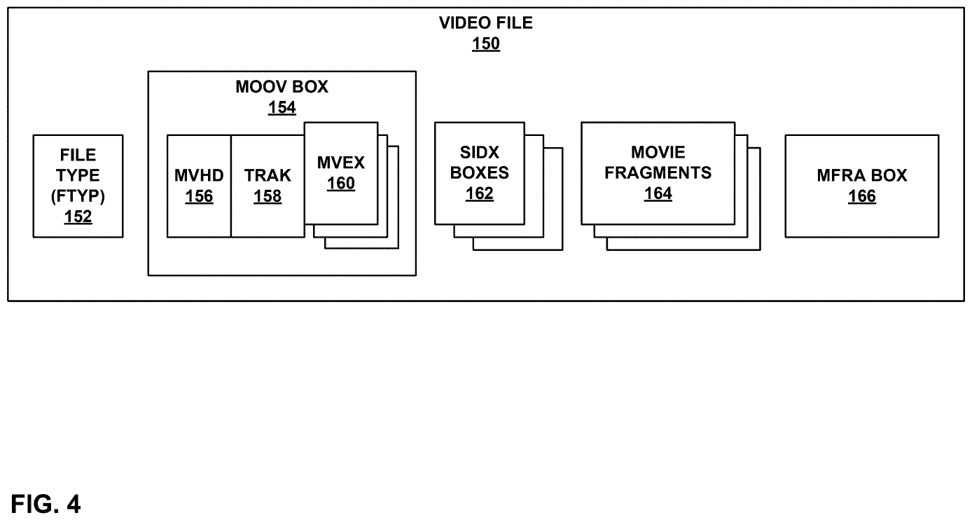

FIG. 4 is a block diagram illustrating elements of an example video file 150, which may correspond to a segment of a representation, such as one of segments 128, 132 of FIG. 3. Each of segments 128, 132 may include data that conforms substantially to the arrangement of data illustrated in the example of FIG. 4. Video file 150 may be said to encapsulate a segment. As described above, video files in accordance with the ISO base media file format and extensions thereof store data in a series of objects, referred to as “boxes.” In the example of FIG. 4, video file 150 includes file type (FTYP) box 152, movie (MOOV) box 154, segment index (sidx) boxes 162, movie fragment (MOOF) boxes 164, and movie fragment random access (MFRA) box 166. Although FIG. 4 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

In some examples, a Segment, such as video file 150, may include an MPD update box (not shown) before FTYP box 152. The MPD update box may include information indicating that an MPD corresponding to a representation including video file 150 is to be updated, along with information for updating the MPD. For example, the MPD update box may provide a URI or URL for a resource to be used to update the MPD. As another example, the MPD update box may include data for updating the MPD. In some examples, the MPD update box may immediately follow a segment type (STYP) box (not shown) of video file 150, where the STYP box may define a segment type for video file 150.

MOOV box 154, in the example of FIG. 4, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 3) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture includes one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub) segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 4). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

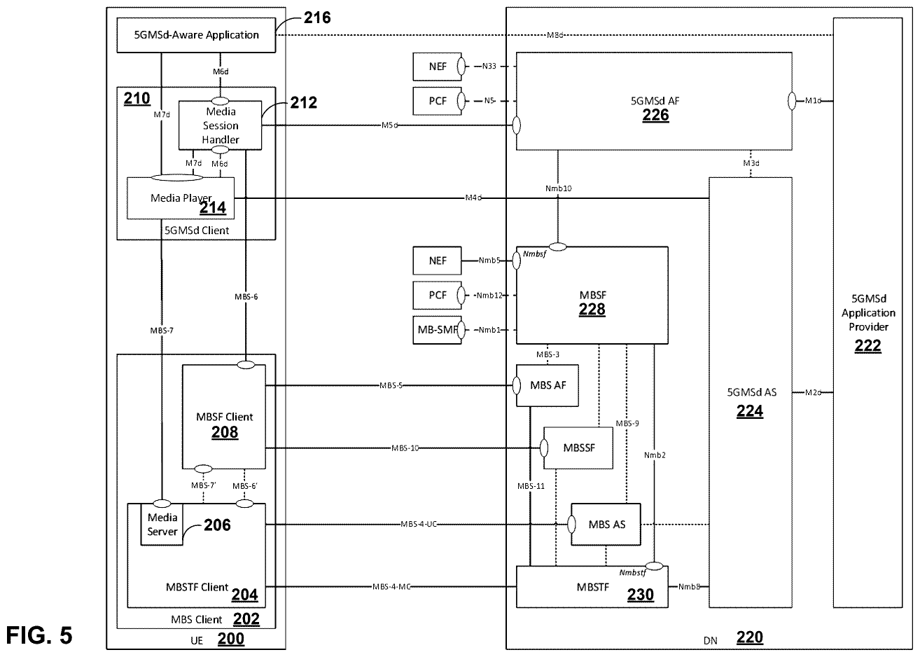

FIG. 5 is a block diagram illustrating an example distribution network (DN) 220 and a user equipment (UE) device 200 that may perform the techniques of this disclosure. Distribution network 220 includes 5G Media Streaming downlink (5GMSd) application provider (5GMSd AP) device 222, 5GMSd application server (5GMSd AS) device 224, 5GMSd application function (5GMSd AF) device 226, and various multicast/broadcast service (MBS) devices, such as multicast/broadcast server function (MBSF) 228 and multicast/broadcast server transport function (MBSTF) 230. UE device 200 includes 5GMSd client 210 including media session handler (MSH) 212 and media player 214, 5GMSd-aware application 216, and MBS client 202 including MBSF client 208 and MBSTF client 204 including media server 206. Media server 206 of MBSTF client 204 may correspond to eMBMS middleware unit 100 of FIG. 2.

UE device 200 of FIG. 5 may correspond to client device 40 of FIG. 1. The various MBS elements of distribution network 220 may correspond to server device 60 of FIG. 1 or proxy server unit 102 of FIG. 2. 5GMSd AP 222 may correspond to content preparation device 20 of FIG. 1.

In various deployment scenarios and specifications, distribution of streaming content such as DASH, HLS, or common media access format (CMAF) data, may be streamed via a broadcast or multicast transmission. Examples include 5GMS via enhanced multimedia broadcast multicast service (eMBMS), 5GMS via MBS, digital video broadcast (DVB) adaptive bitrate (ABR), ATSC 3.0, 5G broadcast, or digital video broadcasting-Internet (DVB-I) over 5G broadcast. In general, a client device or edge gateway device includes a media server, which serves as a communication endpoint for the media player and is populated with content distributed over broadcast/multicast, such as a download delivery session using FLUTE or ROUTE.

In some examples, DN 220, via 5GMSd application provider device 222, may provide main media content for a media presentation to one or more client devices, such as UE 200. MBSTF 230 may transmit main media content (e.g., a first media variant) as a broadcast or multicast (BC/MC) distribution over the MBS-4-MC interface. On UE 200, MBSTF client 204 may receive this broadcast distribution, and media server 206 (acting as a server unit or local proxy) stores the main media content, similar to cache 104 in FIG. 2.

Media player 214 (acting as a DASH or HLS client) requests media data from media server 206. This request may be a conditioned request that includes personalization data, such as a Common Media Client Data (CMCD) token or a watermark token. Media server 206 includes a request and response function to process the request and the included personalization data. Media server 206 also has access to configuration data (e.g., from a manifest file) indicating that personalization data can be selectively exchanged via unicast.

Based on the configuration data and the received personalization data, media server 206 may determine that at least a portion of personalization data is to be exchanged. Media server 206 may then issue a selective unicast request for the personalization data. This request may be for a second, different media variant, or for a specific byte range of a media segment. This selective unicast request is transmitted via the MBS-4-UC interface toward 5GMSd AS 224 or 5GMSd AP 222. Media server 206 may receive the personalization data in response to the unicast request and may provide the final personalized media data to media player 214 for presentation.

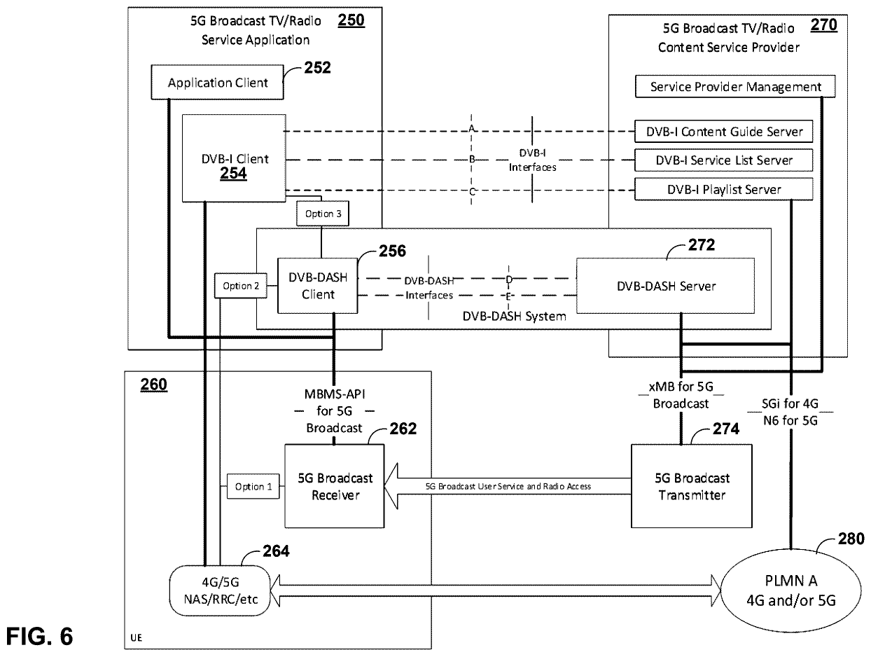

FIG. 6 is a block diagram illustrating an example set of devices that may perform hybrid transmission services per techniques of this disclosure. FIG. 6 depicts 5G broadcast TV/radio service application 250, 5G broadcast TV/radio content service provider 270, UE device 260, 5G broadcast transmitter 274, and PLMN A 280 for 4G or 5G. In this example, 5G broadcast/TV radio service application 250 includes application client 252, DVB-I client 254, and DVB-DASH client 256. In this example, UE 260 includes 4G/5G NAS/RRC unit 264 and 5G broadcast receiver 262. In this example, 5G broadcast TV/radio content service provider includes, among other components, DVB-DASH server 272.

In this example, a media player of UE device 260 may simultaneously request and consume resources from a unicast server, e.g., a content delivery network (CDN) or a server unit for UE 260, such as 5G broadcast TV/radio service application 250 or a proxy server within UE 260.

In this example, for DVB-I, there are three options depicted for including both broadcast/multicast and unicast content. In Option 1, 5G broadcast receiver 262 accesses a unicast network (e.g., via 4G/5G NAS/RRC unit 264). In Option 2, DVB-DASH client 256 selects content from different networks (e.g., from 5G broadcast receiver 262 or DVB-DASH Server 272). In Option 3, the application (in this example, DVB-I client 254) selects content from different networks. The unicast content may include any or all of alternative languages (audio and/or timed text/closed captions), advertisement insertion, coverage extensions, or the like.

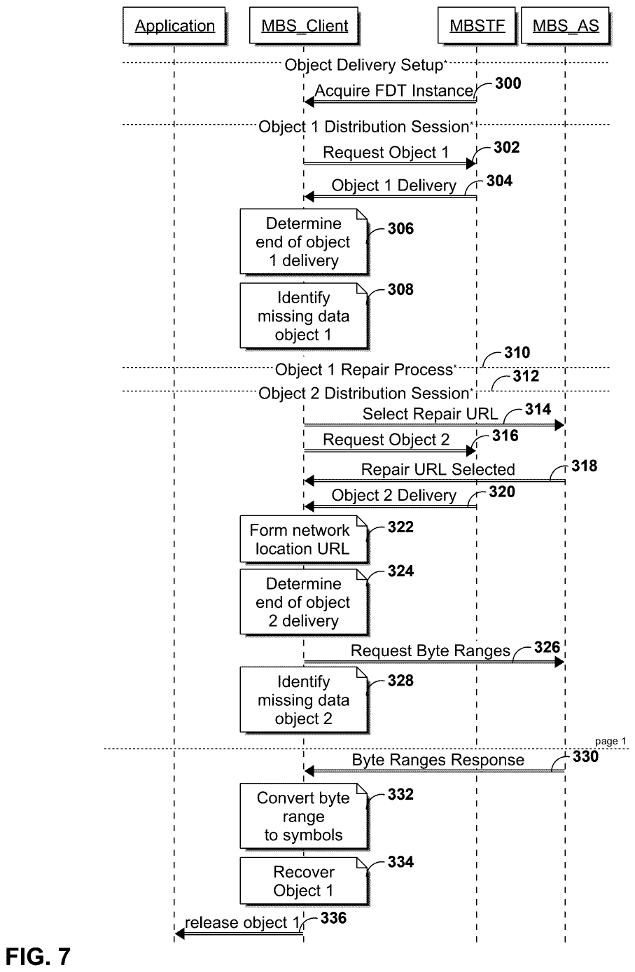

FIG. 7 is a flow diagram illustrating an example of unicast repairs to media streamed via broadcast/multicast. In-session unicast repair for multicast/broadcast service (MBS) is also available to MBMS. Per the example of FIG. 7, a client device (or a server unit that acts as an endpoint for a multicast/broadcast service) may determine that a broadcast/multicast service is failing or at least partially failing, and thus, that broadcast/multicast media data is not completely received. In response, the MBS client (e.g., the client device or the server unit acting as an endpoint for the MBS) may request repair data via unicast.

In this example, the process begins with an object delivery setup phase, during which the MBS Client acquires a File Delivery Table (FDT) instance (300) from the MBSTF. During an Object 1 Distribution Session, the MBS Client may send a request for a first object (“Object 1”) (302), and the MBSTF, in response, sends the first object (Object 1) (304) to the MBS Client, for example, via a broadcast or multicast distribution. The MBS Client may determine an end of Object 1 delivery (306) and determine whether any data is missing for Object 1. It is assumed, in this example, that at least some data is missing for Object 1, and thus, the MBS client determines which data is missing (308).

The MBS client may issue requests for unicast repair data based on a local decision at an appropriate time. For example, the MBS client may determine that successful reception of a damaged media segment is no longer possible via broadcast/multicast. In response, the MBS client may request repair data via unicast.

The identification of the missing data may trigger an Object 1 repair process (310). An Object 2 distribution session (312) may commence to provide the repair object for Object 1. In this example, the MBS Client selects a repair URL (314) and sends a request for a second object (Object 2) (316) to the MBSTF. The MBS AS may confirm the repair URL selected (318), and the MBSTF then provides Object 2 Delivery (320), for example, via a unicast transmission.

In some examples, the repair may be for specific byte ranges of Object 1. The MBS Client may form a network location URL (322) and determine the end of Object 2 delivery (324). If the MBS Client identifies missing data for Object 2 (328), MBS Client may send a request for missing byte ranges (326) directly to the MBS AS. The MBS AS may then provide a byte ranges response (330). Upon receiving the byte ranges, the MBS Client converts the received data of the byte range to symbols (332) and recovers Object 1 (334). Finally, the MBS client releases the recovered Object 1 (336) to the media application. This flow provides an example of in-session unicast repair, though in other examples, the repair may be a post-session repair.

Various streaming services include personalization data. For example, streaming services may include requests from the media player including personalized information, such as identifiers for the user, specific tokens, device identifiers, tracking data, or other client data such as that defined for common media client data (CMCD). Responses to such requests may be customized by the content delivery network (CDN) or some edge server based on information included in the requests. Table 1 below summarizes examples of customized requests and corresponding customized responses:

TABLE 1

| CUSTOMIZED REQUEST | CUSTOMIZED RESPONSE |
|---|---|
| Ad tracking and beaconing | Monetization incentives, ad |
| | skipping possible |
| DRM and license key requests | License keys |
| Common Media Client Data (CMCD) | — |
| Identifiers used by Ad Decision systems | Targeted dynamic ad content |
| Tokens used by A/B watermarking | Variants of A/B watermarking |
| schemes | |

These functionalities may be used when radio access network (RAN) broadcast, such as 5G broadcast, or MBS are used for media distribution.

This disclosure describes various solutions for exchanging personalization data when media data is broadcast or multicast. In some examples, the media player handles the unicast requests for personalization data. The manifest file, e.g., an MPD, may include discrimination data for requests to a local media server (which may be a proxy server included in the UE, such as proxy server unit 102 as shown in FIG. 2, or a separate local server device) that receives main media content via broadcast/multicast transmission. The manifest file may also include discrimination data for unicast requests for personalization data. For example, there may be separate service locations for the main media content and the personalization data. Likewise, the main media content and the personalization data may be associated with distinct URLs (e.g., different base URLs, corresponding to the different service locations). The media player may send the unicast requests directly to the network (per the manifest file) and handle request issues. Generally, this may be a viable option with some limitations. For example, if the request to a broadcast resource is bundled with unicast related data, the information terminates in the local media server (CMCD, tokens, etc.) The differentiated request may be to some extent obfuscated to the client and the response logic may be a network server. There may also be general issues of scalability, such that many requests would go to unicast.

Thus, as an alternative, in some examples, an MBS client (e.g., an MBMS client, a 5G broadcast client, or the like, which may be a proxy server within the UE device or a separate local server device) may handle the unicast requests. In such examples, the DASH (or other HTTP) client may send conditioned requests to the local or gateway server. The gateway server may not only serve the requested resources, but also process additional information provided with the request and potentially issue unicast requests based on the resources. The requested resource may be served from the broadcast distribution, or it may be served by issuing a unicast request or, as in the case of unicast repair, it may be a combination of the two. These techniques may be applicable to MBS, MBMS, DVB ABR, DVB-NIP, and/or ATSC 3.0.

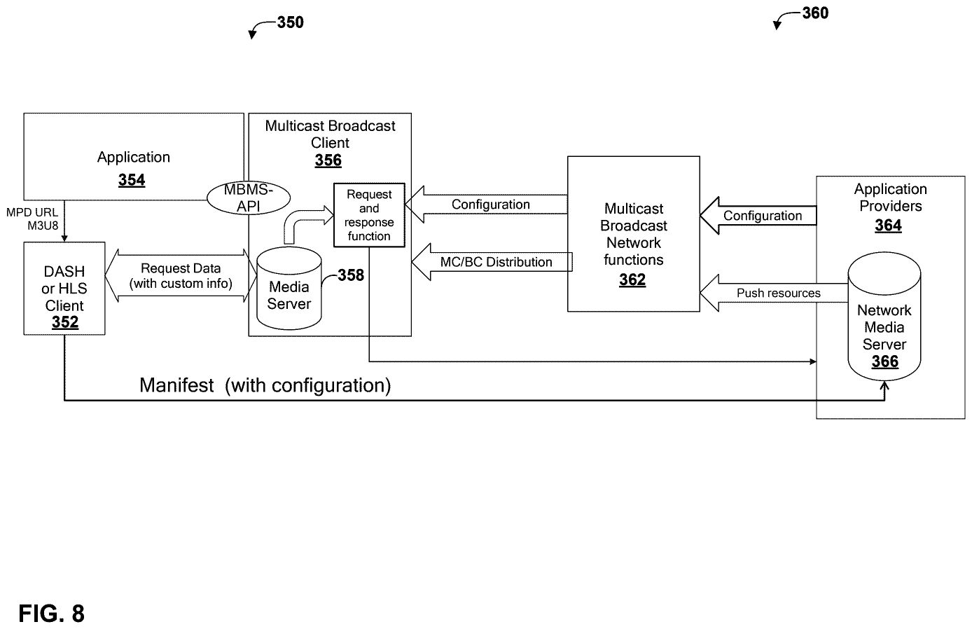

FIG. 8 is a block diagram illustrating a basic architecture and function of a system that may perform the techniques of this disclosure. FIG. 8 depicts client system 350 and source system 360. Source system 360 includes application providers 364 and multicast broadcast network functions 362 (which may together correspond to content preparation device 20 and/or server device 60 of FIG. 1). Application providers 364 include network media server 366. Client system 350 includes application 354 and DASH/HLS client 352 (which, together, may correspond to client device 40 of FIG. 1), and multicast/broadcast client 356. Multicast/broadcast client 356 includes media server 358. Multicast/broadcast client 356 (or media server 358) may operate as a server unit, corresponding to a separate server device or to a proxy server included in middleware of the client device, such as proxy server unit 102 of FIG. 2.

In this example, a request and response function executed by multicast/broadcast client 356 collects information and communicates the information with unicast application providers 364. In general, application providers 364 may configure multicast/broadcast network functions 362 for distribution and to manage requests and responses from clients including DASH/HLS client 352. Application providers 364 may provide the configuration information in a service announcement to multicast/broadcast client 356. Multicast/broadcast client 356 uses the request information received from DASH/HLS client 352 (which may include custom information, such as personalization data) to possibly adapt responses and/or to possibly selectively request information from application providers 364 (e.g., from network media server 366) via unicast.

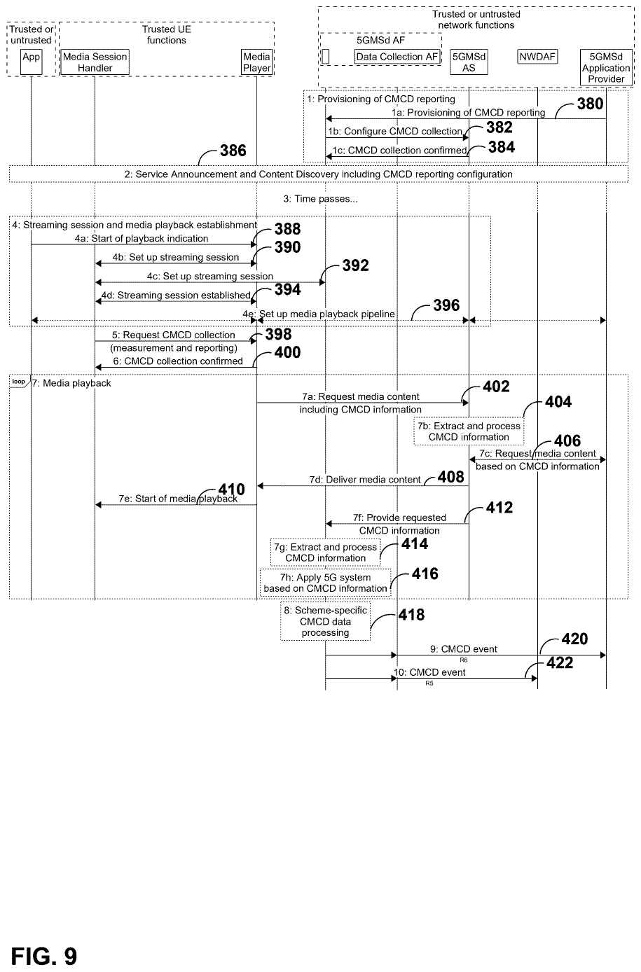

FIG. 9 is a call flow diagram illustrating an example process of sending common media client data (CMCD) as personalization data when main media content is initially sent via broadcast or multicast per techniques of this disclosure. The process of FIG. 9 involves interactions between trusted or untrusted UE functions (e.g., a media application, a Media Session Handler, and a Media Player) and trusted or untrusted network functions (e.g., 5GMSd AF, Data Collection AF, 5GMSd AS, Network Data Analytics Function (NWDAF), and 5GMSd Application Provider). The process of FIG. 9 may be performed by, for example, client device 40 and server device 60/content preparation device 20 of FIG. 1; UE 200 (including 5GMSd-aware application 216, media session handler 212, media player 214, and media server 206) and DN 220 (including 5GMSd application provider device 222, 5GMSd AS 224, and 5GMSd AF 226) of FIG. 5; UE 260 (including 5G broadcast TV/radio service application 250, 5G broadcast receiver 262, DVB-I client 254, and DVB-DASH client 256) and 5G broadcast TV/radio content service provider 270 of FIG. 6; and/or client system 350 (including application 354, DASH or HLS client 352, and multicast broadcast client 356) and source system 360 (including multicast broadcast network functions 362 and application providers 364) of FIG. 8.

A server unit for a client device, such as a server device or proxy server, may initially receive main media content via broadcast or multicast from, e.g., an application provider device. A DASH or HLS client may then request the main media content and include, in the request, CMCD data as personalization data to be passed to the application provider device. An HTTP request may be, e.g., an HTTP Get or partial Get request. The HTTP request may specify a base URL of a location from which to retrieve media data (e.g., a base URL that is translated to an IP address via DNS when the server is a separate device, or a localhost IP address when the proxy server is part of the client device).

The HTTP request may also include a header option and/or a query option. The query option may be expressed following the URL following a question mark ‘?’. The header option may be expressed in a header portion of the request. For example:
GET/segment3456.m4s?custom-data-a=1,b=2
custom-request-header: a=1,b=2
   In this example, “?custom-data=a=1,b=2” represents an example query option, while “custom-request-header: a=1,b=2” represents an example header option. Generally, HTTP requests for a media segment may include custom data as either or both of an HTTP header or a query string appended to the segment request URL.

In the example call flow diagram of FIG. 9, which is adapted to 5G media streaming, information may be collected in the 5GMSd AS (network server), then exposed to the application function (AF) by aggregating the information. The information in itself may be sent to the Network Data Analytics Function (NWDAF) or used for optimizing delivery.

In particular, in the example of FIG. 9, a provisioning and configuration phase initially occurs for CMCD. This includes provisioning of CMCD reporting (380) from the 5GMSd Application Provider to the 5GMSd AF. The 5GMSd AF configures CMCD collection (382) with the Data Collection AF. The Data Collection AF confirms the CMCD collection configuration (384). A service announcement and content discovery, including CMCD reporting configuration, is then provided to Media Session Handler (386).

After time passes, a streaming session and media playback establishment occurs (step 4). The application sends a start of playback indication (388) to the Media Session Handler. The Media Session Handler sets up a streaming session (390, 392) with 5GMSd AF. 5GMSd AF confirms the streaming session is established (394). The Media Session Handler and the Media Player then set up the media playback pipeline (396).

During media playback, the Media Player may request CMCD collection (398) from the 5GMSd AF, which in turn confirms the collection (400). The Media Player starts media playback (410) and sends a request for media content that includes CMCD information (402) to 5GMSd AS. This request may be an HTTP Get or partial Get request. The HTTP request may specify a base URL of a location from which to retrieve media data. The request may also include custom data, such as the CMCD, as an HTTP header or as a query string appended to the segment request URL.

The 5GMSd AS, operating as a server unit for the UE in this example, receives the request. The 5GMSd AS extracts and processes the CMCD information (404). The 5GMSd AS may then request the media content based on that CMCD information (406) from the 5GMSd Application Provider. The 5GMSd AS delivers the media content (408) to Media Player. In this 5G media streaming example, the 5GMSd AS also provides the requested CMCD information (412) to the Data Collection AF. The Data Collection AF extracts and processes the CMCD information (414) and may apply a 5G system based on the CMCD information (416). Following scheme-specific CMCD data processing (418), the Data Collection AF may send a CMCD event (420) to the NWDAF and a CMCD event (422) to the 5GMSd AF. This process allows the system to aggregate CMCD information at the network level, which may be used to optimize delivery.

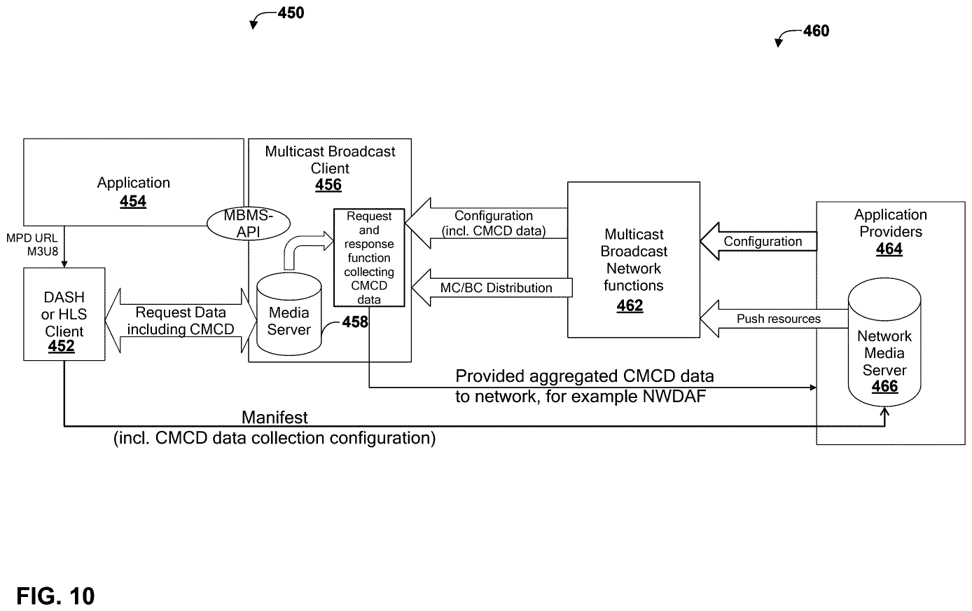

FIG. 10 is a block diagram illustrating an example system that may be adapted to send and receive CMCD data per techniques of this disclosure. FIG. 10 depicts client system 450 and source system 460. Client system 450 includes DASH/HLS client 452, application 454, and multicast/broadcast client 456, which includes media server 458. Multicast/broadcast client 456 may be a separate server device or included within the client device (e.g., as in the case of proxy server unit 102 of FIG. 2) that also includes application 454 and DASH/HLS client 452. Source system 460 includes multicast/broadcast network functions 462 and application providers 464, which in turn includes network media server 466. Source system 460 may collectively correspond to content preparation device 20 and/or server device 60 of FIG. 1.

The example of FIG. 10 includes a general architecture and call flow that is adapted to configure DASH/HLS client 452 for CMCD data collection (e.g., in a manifest file). DASH/HLS client 452 may send a request for data including CMCD. Multicast/broadcast client 456 is configured to collect the CMCD data from DASH/HLS client 452 via a request and response function. Multicast/broadcast client 456 provides aggregated information to multicast/broadcast network functions 462, for example, an NWDAF, which may then cause the CMCD data collection for broadcast/multicast to be aligned with CMCD data collection for unicast. Application providers 464 provides configuration for this operation to multicast broadcast network functions 462 (which provides MC/BC Distribution) and to multicast broadcast client 456.

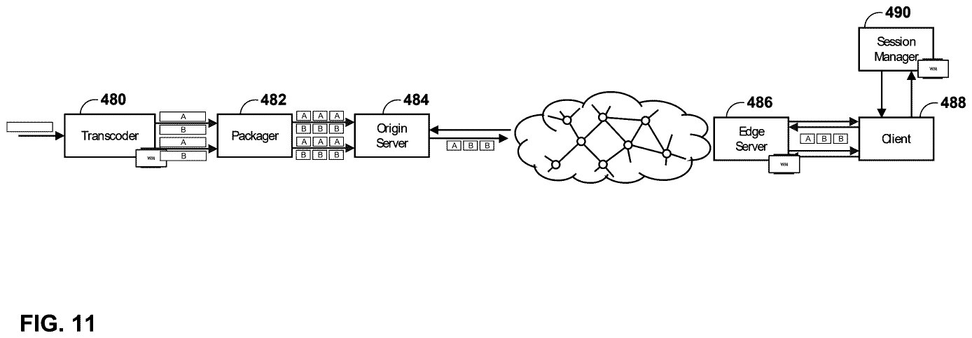

FIG. 11 is a block diagram illustrating an example system for exchanging watermarked data per techniques of this disclosure. Forensic watermarking refers to embedding of an imperceptible, unique identifier within copies of content for the purpose of tracking individual copies to deter unauthorized redistribution. Forensic watermarking remains in the media content even after other content protection features have been removed, e.g., after DRM/CAS decryption is applied, after the content has left the Secure Video Path, and so on.

The system of FIG. 11 illustrates an example of server-side watermarking. A media stream is received at transcoder 480, which generates different variants (e.g., A/B variants). Packager 482 packages the variants into segments for different representations. Origin server 484 stores the segments. Edge server 486 receives the segments from origin server 484, for example via a network, and provides a selected variant (e.g., A or B) to client 488. Client 488 may interact with session manager 490 to coordinate the session, e.g., to request and receive the segments of the session.

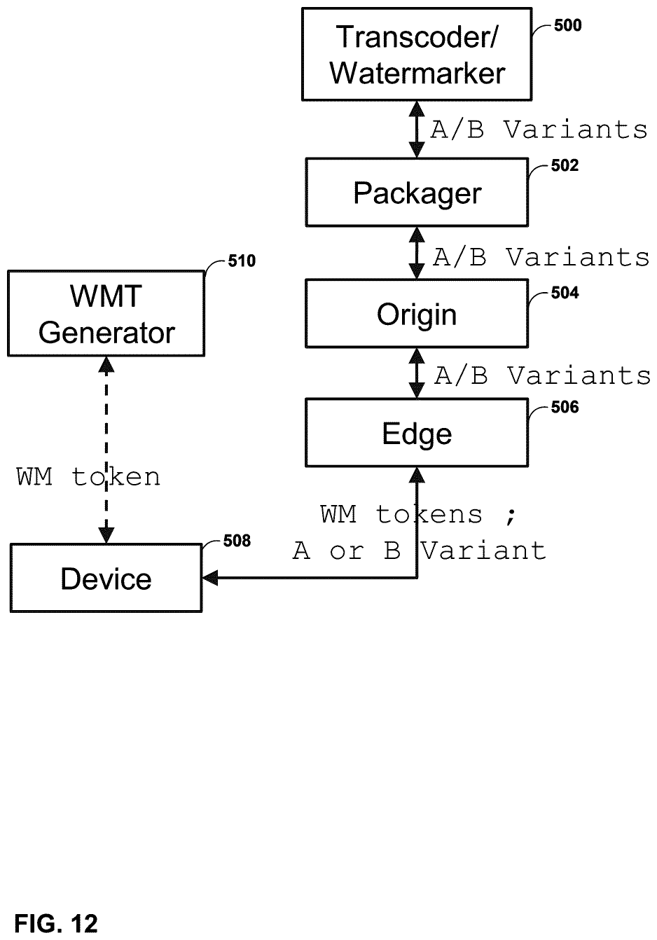

FIG. 12 is a flow diagram illustrating an example watermarking process per techniques of this disclosure. In general, the watermarking architecture is an end-to-end architecture that impacts an encoder (e.g., transcoder/watermarker 500), packager 502, origin 504, edge server device 506, and client device 508. An A/B routing logic may be implemented within edge server device 506. Watermark token (WMT) generator 510 may generate watermark tokens and transmit the watermark tokens to edge server device 506. The watermark token may include a unique A/B pattern for a particular client device, e.g., client device 508. An encoder may send an explicit metadata stream (e.g., WMPaceInfo metadata) to edge server device 506 to signal which watermark ID (WMID) bit is associated with a given egress segment. Edge server device 506 may use the watermark tokens to select and send an A or B variant to client device 508.

The watermark token may carry a unique identifier from client device 508 to a content distribution network (CDN), and may be required for client device 508 to retrieve content (e.g., for access control and/or billing purposes). The watermark token may be expressed as a Concise Binary Object Representation (CBOR) Web Token (CWT) per, e.g., Jones et al., “CBOR Web Token (CWT),” Internet Engineering Task Force, RFC 8392 May 2018, available at datatracker.ietf.org/doc/html/rfc8392. The WCT token in CBOR format may be aligned with CTA Wave CDN Access Token (CAT). This may reduce the number of formats to be supported. Semantics may be kept for identifying the watermark vendor. In direct mode, the token may carry the watermark pattern, which may be encrypted. In indirect mode, the token may carry parameters to generate the watermark pattern. A standard API may be defined for integrated any needed extensions for supporting indirect mode.

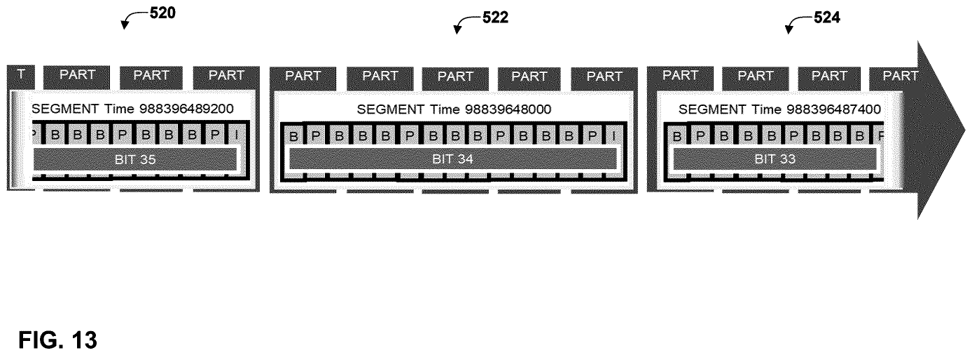

FIG. 13 is a conceptual diagram illustrating an example set of watermark pace information (WMPaceInfo). The WMPaceInfo is metadata describing watermark who, what, when, where, why, and how. When a client device requests a Segment of media data, the edge server device sequencing logic may need to determine which bit in the unique watermark pattern to consider for retrieving either A or B variant of the requested Segment before delivering the Segment to the client device. WMPaceInfo contains a mapping <Segment, Bit>, in addition to some data needed for content preparation. The encoder transmits WMPaceInfo (combined with the watermarking pre-processor) to various server devices that may need the WMPaceInfo, such as, for example, the packager, the origin server, and/or the edge server.

As shown in the example of FIG. 13, different segments correspond to different bits in the watermark pattern. For example, a first segment 520 (Segment Time 988396489200) corresponds to BIT 35 of the pattern. A second segment 522 (Segment Time 98839648000) corresponds to BIT 34. A third segment 524 (Segment Time 988396487400) corresponds to BIT 33. The encoder transmits WMPaceInfo (combined with the watermarking pre-processor) to various server devices that may need the WMPaceInfo, such as, for example, the packager, the origin server, and/or the edge server.

Example WMPaceInfo data is summarized in Table 2 below:

TABLE 2

| Attribute | Producer | Consumers | Purpose |
|---|---|---|---|
| Variant | Encoder | Edge | Integration, Debugging |
| Position | Encoder | Edge | Bit position in the watermark |
| | | | pattern |
| FirstPart | Encoder | Packager, | Egress packaging |
| | | Origin | |
| LastPart | Encoder | Packager, | Egress packaging |
| | | Origin | |

The following pseudocode represents an example class definition for WMPaceInfo:

| class WMPaceInfo { | |
|---|---|
| unsigned int(8) | version; |
| unsigned int(8) | variant; |
| unsigned int(1) | emulation_1; |
| unsigned int(15) | position; |
| unsigned int(1) | emulation_2; |
| unsigned int(1) | firstpart; |
| unsigned int(1) | lastpart; |
| unsigned int(5) | reserved; |

}

WMPaceInfo may be conveyed using various ingest protocols and corresponding delivery options as shown in the example of Table 3 below:

TABLE 3

| Ingest Protocol | WMPaceInfo delivery options |
|---|---|
| RTMP | SEI |
| RTP/UDP/RIST/SRT | SEI, TS adaptation field |
| HLS/TS over HTTP Post | HTTP header, SEI |
| CMAF-based protocols/formats | HTTP header, ISOBMFF box, |
| (HLS/fMP4, DASH) over HTTP POST | SEI |
| File access protocol | ISOBMFF box, SEI, sidecar file |

The following represents an example JavaScript Object Notation (JSON) format for WMPaceInfo ingestion:

| WMPaceInfoIngest : { | |
|---|---|
| “version”: | version, |
| “variant”: | variant, |
| “position”: | position, |
| “firstpart”: | firstpart, |
| “lastpart”: | lastpart |

}

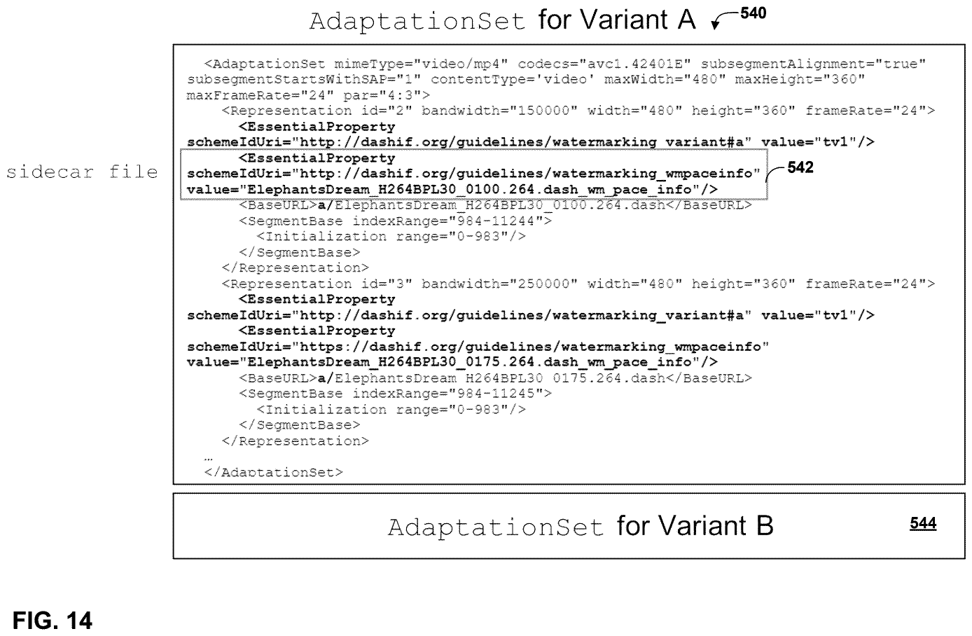

FIG. 14 is a conceptual diagram illustrating examples of a sidecar approach to providing A and B variants of watermarked segments in a manifest file per techniques of this disclosure. Different AdaptationSets may be provided for each variant of watermarked segments, e.g., Variant A and Variant B. FIG. 14 depicts an example AdaptationSet for Variant A 540 and an AdaptationSet for Variant B 544. AdaptationSet for Variant A 540 includes various Representation elements. Each Representation element may include an EssentialProperty element 542 that defines a URL from which a sidecar file can be retrieved.

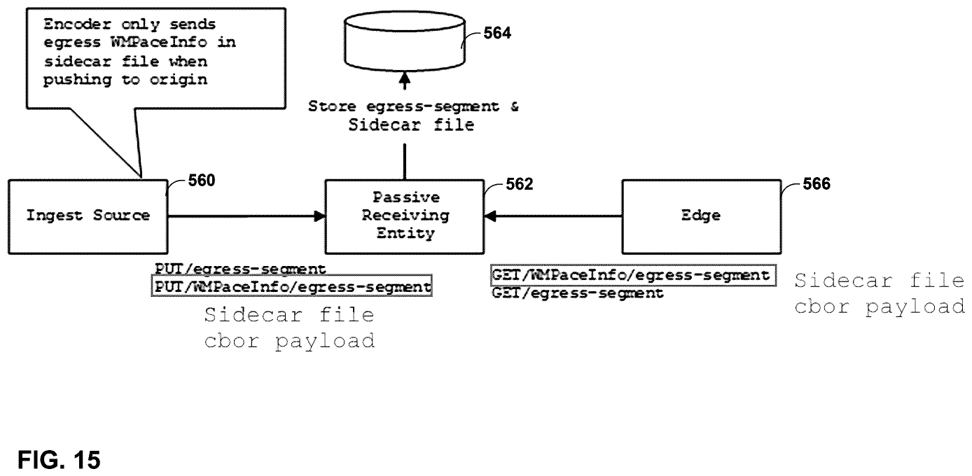

FIG. 15 is a conceptual diagram illustrating an example of using WMPaceInfo in live workflows per techniques of this disclosure. This may be used in a passthrough origination scenario. In this example, ingest source 560, which may include an encoder, sends egress WMPaceInfo in a sidecar file when pushing to an origin. Ingest source 560 sends a PUT request for the egress-segment and a PUT request for the WMPaceInfo sidecar file (e.g., as a CBOR payload) to passive receiving entity 562.

Passive receiving entity 562, which may be an origin server, receives these requests and stores the egress-segment and the sidecar file, as shown by storage 564. At a later time, edge server device 566, which may be an edge server, sends requests to retrieve the media and associated watermarking metadata. Edge server device 566 sends a GET request for the WMPaceInfo (e.g., GET/WMPaceInfo/egress-segment) and a GET request for the media segment (e.g., GET/egress-segment) to passive receiving entity 562. Passive receiving entity 562 provides the requested sidecar file and egress segment, allowing edge server device 566 to access the necessary WMPaceInfo to perform A/B variant selection for a client device.

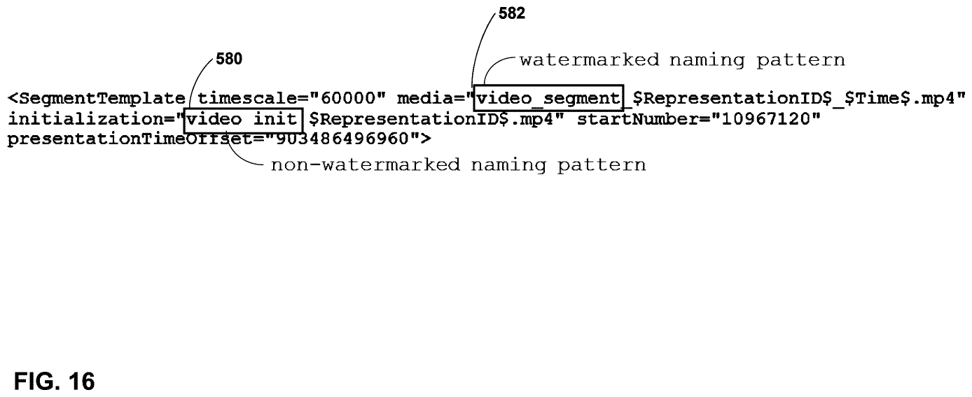

FIG. 16 is a conceptual diagram illustrating an example watermarked naming pattern and an example non-watermarked naming pattern. In this example, “video_segment” represents an example of a watermarked naming pattern (watermarked naming pattern 582), while “video init” represents an example of a non-watermarked naming pattern (non-watermarked naming pattern 580). A content delivery network (CDN) may be configured to enable or disable edge sequencing logic. That is, CDN configuration may indicate whether to enable or disable edge sequencing logic. When sequencing is disabled, the edge server device may pull segments from the origin endpoint for Variant A. If this endpoint is not working properly, the origin may deliver any available variant on this endpoint. Watermarked object names may include a pattern that the CDN can match to differentiate these objects from non-watermarked objects (e.g., initialization segments, subtitles, trickplay images, or the like). When pulling segments from the origin server, the edge server may translate “variantID” into “variantPath” as:
variantPath=${variantID}, followed by
if ${variantId} is a or 0, then ${variantPath} may be empty.

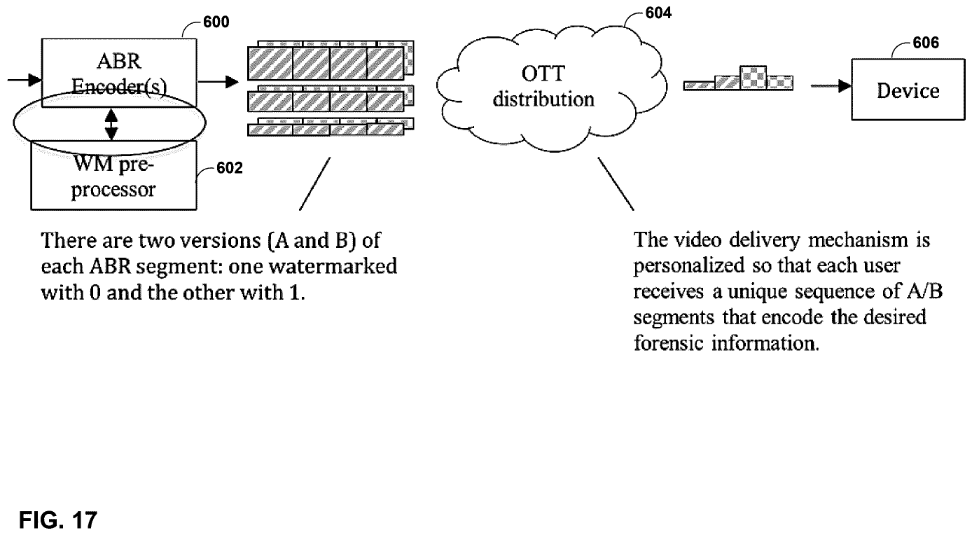

FIG. 17 is a conceptual diagram illustrating an example architecture for sending watermarked media data. In this example architecture, adaptive bitrate (ABR) encoder(s) 600 work in conjunction with watermark (WM) pre-processor 602. This combination generates two versions (e.g., A and B) of each ABR segment, such as one watermarked with 0 and the other with 1. The segments are then delivered via over the top (OTT) distribution network 604 to device 606. The video delivery mechanism is personalized so that each user (e.g., operating device 606) receives a unique sequence of A/B segments that encode desired forensic information.

Various APIs for encoder/watermarking integration, such as between ABR Encoder(s) 600 and WM pre-processor 602, have been specified. These APIs allow an encoder and a watermarking system to process video content and output variants. There are two flavors of the API, one for watermarking technologies that process baseband video content, and one for watermarking technologies that process compressed video content. In addition to A/B variants, multiple variants may be generated, or just a single variant that adds a watermark. Typically, only a subset of the frames in a segment are watermarked, while the rest are not.

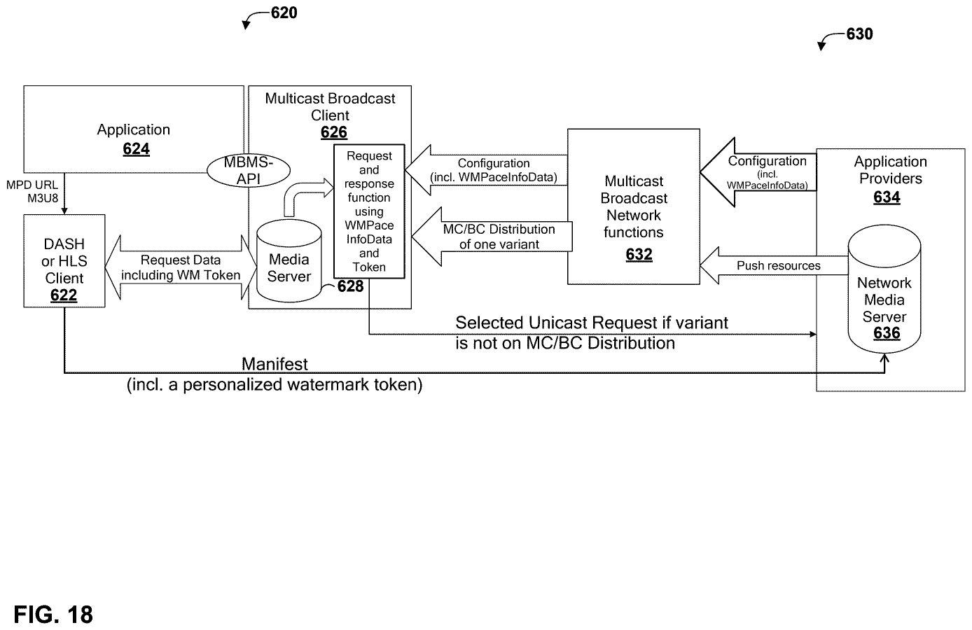

FIG. 18 is a block diagram illustrating an example architecture for integrating watermarking into multicast/broadcast per techniques of this disclosure. The architecture includes client system 620 and source system 630. Source system 630 includes application providers 634 (with network media server 636) and multicast/broadcast network functions 632. Client system 620 includes DASH/HLS client 622, application 624, and multicast broadcast client 626. Multicast/broadcast client 626, which includes media server 628, may operate as a server unit for a client device including application 624 and DASH/HLS client 622. For example, application providers 634 and multicast broadcast network functions 632 may jointly correspond to content preparation device 20 of FIG. 1. Multicast/broadcast client 626 and media server 628 may correspond to, e.g., a separate server device (such as an edge server device) or proxy server unit 102 of FIG. 2 (implemented in middleware of the client device).

In this example operation, application providers 634 provide configuration data, including WMPaceInfoData, to multicast/broadcast network functions 632, which delivers corresponding configuration information to multicast/broadcast client 626. Application providers 634 also provide a manifest (which may include a personalized watermark token) to DASH/HLS client 622. Multicast broadcast network functions 632 distributes a single variant of the main media content (e.g., “MC/BC Distribution of one variant”) to multicast broadcast client 626.

DASH/HLS client 622 sends a request for data, including the WM Token, to media server 628. A request and response function of multicast broadcast client 626 processes this request using the WMPaceInfoData and the received WM Token. Based on the token and this information, multicast broadcast client 626 determines whether to use the media data from the MC/BC distribution or if a different variant is needed. If a different variant is needed, multicast broadcast client 626 issues a “Selected Unicast Request if variant is not on MC/BC Distribution” to retrieve that specific variant (personalization data) from network media server 636. Multicast broadcast client 626 may buffer each received variant for retrieval by DASH/HLS client 622.

In this example, multicast/broadcast network functions 632 distribute a single variant by broadcast or multicast to multicast/broadcast client 626. If a different variant is needed, multicast/broadcast client 626 may request that variant via unicast from application providers 634. Multicast/broadcast client 626 may buffer each received variant of each segment for retrieval by the DASH/HLS client 622. In this example, the information on mapping requests to variants may be provided through side car information data shared to client system 620 via service announcement configuration and the unicast/watermark token. Based on the watermark token and the information, multicast/broadcast client 626 determines whether to use the information from the multicast/broadcast distribution or if variant content is to be requested via unicast.

In further examples designed to better optimize unicast traffic, the differentiating watermarking data may be concentrated into a specific byte range of the media segments. In such a case, multicast/broadcast client 626 may not need to request the entire personalized segment via unicast. Instead, multicast/broadcast client 626 may issue a unicast request for only the well-defined byte range that contains the unique personalization data. Upon receiving this byte range, multicast/broadcast client 626 may replace the corresponding portion of the segment received via the broadcast or multicast transmission. This approach may require a watermark that does not propagate over predicted frames, thereby ensuring that the byte-range replacement does not cause decoding artifacts.

In some deployment scenarios, the selection of media variants may be adjusted to further minimize unicast traffic. While unicast-only A/B variants may be selected with equal likelihood, in a hybrid system where one variant (e.g., Variant A) is distributed via broadcast, the system may be configured to select the other variants (e.g., Variant B) less frequently. This biased selection may reduce the number of unicast requests, though it may also reduce the total number of possible unique watermark patterns over a given period. This represents a deployment choice to balance the desired detection speed of forensic watermarking against the need to control unicast network load.

Furthermore, while the examples in this disclosure frequently refer to A/B variants for simplicity, the techniques are not limited to two variants. In another embodiment, more than two variants of a media segment could be created (e.g., Variants A, B, and C). In such a scenario, one variant may be sent via broadcast, while the multiple other variants are available for selective retrieval via unicast. This allows for the creation of more complex and unique sequences for purposes such as forensic watermarking.

In some examples, differentiating watermarking data may be concentrated to some byte range of the segments. In this case, rather than requesting the entire segment via unicast, only a well-defined byte range may be watermarked and requested, such that the multicast/broadcast client may replace the portion of the received segment with the retrieved byte range. The watermark may be defined so as not to propagate over predicted frames.

In unicast, A/B variants may generally be selected with equal likelihood. However, if only the A variant is distributed over broadcast, the other variants may be selected less often to minimize unicast traffic. This may reduce the amount of possible unique watermark patterns. There is a deployment choice to balance the duration of unique patterns and the detection speed in forensic watermarking and the unicast requests.

In some examples, more than two variants may be created. This allows for more variants for the unicast request, to create more unique sequences.

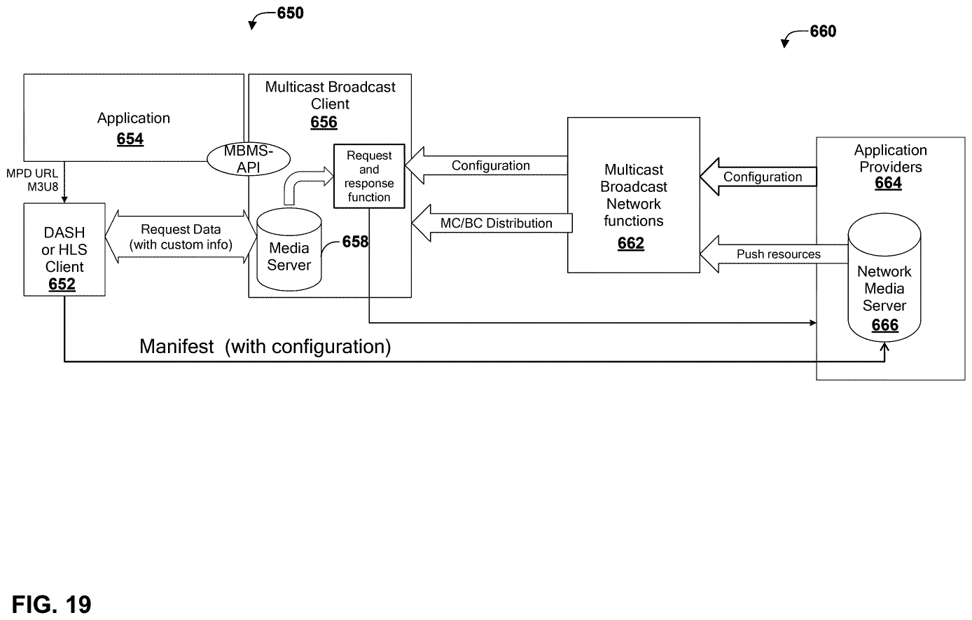

FIG. 19 is a block diagram illustrating an example architecture for performing the techniques of this disclosure. In general, an application provider provides configuration information and main media content to a multicast/broadcast client via a multicast/broadcast network function. The application provider and the multicast/broadcast network function may correspond to content preparation device 20 of FIG. 1. The multicast/broadcast client may correspond a separate server device (e.g., an server device) or a local proxy server implemented in middleware of the client device, e.g., proxy server unit 102 of FIG. 2.

FIG. 19 depicts client system 650 and source system 660. Source system 660 includes application providers 664 (with network media server 666) and multicast broadcast network functions 662. Client system 650 includes application 654, DASH/HLS client 652, and multicast broadcast client 656. Multicast broadcast client 656 includes media server 658. In general, application providers 664 provides configuration information and main media content (e.g., via Push resources) to multicast broadcast network functions 662. Application providers 664 also provides configuration to multicast broadcast client 656. Multicast/broadcast network functions 662 provides the main media content via MC/BC Distribution to multicast/broadcast client 656. Application providers 664 and multicast/broadcast network functions 662 may correspond to content preparation device 20 of FIG. 1. Multicast/broadcast client 656 may correspond to server device 60 of FIG. 1 or proxy server unit 102 of FIG. 2.

The multicast/broadcast client includes a request and response function that may request unicast delivery of certain content (e.g., watermarked content), while generally receiving the main media content via broadcast/multicast. The request and response function may selectively request personalization data via unicast using selective requests. The selective requests may combine information in HTTP headers, query strings, and/or based on a pattern in the request URL. The selective requests may be sent according to information provided in configuration information, such as a filter indicating when to issue unicast requests. Unicast requests may also be issued based on certain randomization.

The determination by multicast broadcast client 656 to issue a selective unicast request can be based on several mechanisms. For example, the configuration information provided by application providers 664 may include a filter that specifies the conditions under which a unicast request should be triggered. This filter may be based on patterns in the request URL from the client or on specific parameters in the HTTP headers or query strings. In other examples, unicast requests may be issued based on a certain randomization factor, also defined in the configuration, to vary the personalization without a specific trigger from the client request. The resulting unicast requests for personalization data may be forwarded as received from the media client, or they may be modified by multicast broadcast client 656 before being sent to the network. The overall configuration may be designed to account for the scalability of the unicast traffic.

Multicast broadcast client 656 includes a request and response function that may request unicast delivery of certain content (e.g., watermarked content or other personalization data), while media server 658 generally receives the main media content via broadcast/multicast. DASH/HLS client 652 receives a manifest (with configuration) and request data (with custom information) from media server 658. The request and response function may selectively request personalization data via unicast (e.g., from network media server 666) using selective requests. The selective requests may combine information in HTTP headers, query strings, and/or based on a pattern in the request URL, which may be derived from the “custom info.” The selective requests may be sent according to information provided in configuration information, such as a filter indicating when to issue unicast requests. Unicast requests may also be issued based on certain randomization.

Data retrieved via unicast using selective requests may be forwarded to DASH/HLS client 652 as is, or may be modified by multicast/broadcast client 656 or media server 658. The configuration may take into account the ability to scale the unicast traffic.

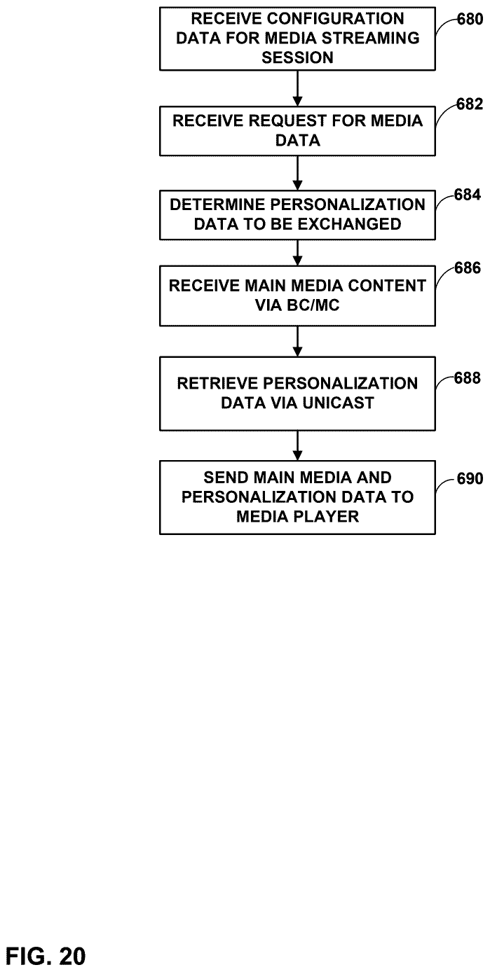

FIG. 20 is a flowchart illustrating an example method of retrieving media data by a server unit on behalf of a client device per techniques of this disclosure. The server unit may be a proxy server (e.g., proxy server unit 102) included in a middleware unit (e.g., eMBMS middleware unit 100) of a client device, or a server device separate from the client device (e.g., server device 60, 5GMSd AS 224, or multicast broadcast client 356, 456, 626, or 656).

Initially the server unit for a client device receives configuration data for a media streaming session (680). This configuration data, which may be received from an application provider device (e.g., application providers 364, 464, 634, 664), indicates that personalization data for the media presentation can be selectively exchanged using a unicast transmission. In some examples, receiving the configuration information includes receiving a service announcement that includes the configuration information.

The server unit may also receive a request for media data from the client device (682). This request, which may be from a media player (e.g., DASH/HLS client 352, 452, 622, 652), includes a request for main media content of the media presentation. The request further includes data representing the personalization data to be retrieved for the media presentation.

Next, the server unit determines that at least a portion of the personalization data is to be exchanged (684). This determination may be based on the received configuration data and the data representing personalization in the client's request. In some examples, the personalization data includes common media client data (CMCD). In other examples, the at least portion of the personalization data includes watermarked data for the media presentation, where the watermarked data corresponds to a watermark token received from the client device.

In examples involving watermarking, a watermark token may indicate a variant pattern for the main media content and the personalization data. For instance, the main media content corresponds to a first variant (e.g., Variant A), and the personalization data corresponds to a second, different variant (e.g., Variant B).

The server unit also receives the main media content via broadcast or multicast (BC/MC) transmission (686). This main media content may be received (e.g., by eMBMS reception unit 106) and stored locally (e.g., in cache 104 or media server 358, 458, 628, 658) prior to or concurrently with the client request.

The server unit then exchanges, via a unicast transmission, the at least portion of the personalization data. This exchange includes retrieving the personalization data via the unicast transmission (688). In some examples, retrieving the personalization data comprises sending a second request, separate from the client's request, comprising an HTTP GET or partial GET request. This second request, sent by the server unit to a network server (e.g., network media server 366, 466, 636, 666), may include a field including the data representing the personalization data (e.g., the watermark token or CMCD data). This field may comprise one of a header option field or a query option field.

In examples where the personalization data includes CMCD, the method may further comprise sending the CMCD to an application provider device of a radio access network (RAN). This operation may allow the network to receive analytics for the broadcast session, thereby aligning the CMCD data collection with that of a standard unicast session.

The server unit then sends the main media content (e.g., from local storage) and the retrieved personalization data (e.g., from the unicast response) to a media player of the client device (690). This may cause the media player to play the media content, including both the main media content and the personalization data.

In this manner, the method of FIG. 20 represents an example of a method of retrieving media data, including: receiving, by a server unit for a client device, configuration data for a media streaming session for a media presentation to be received via broadcast or unicast, the configuration data indicating that personalization data for the media presentation can be selectively exchanged using a unicast transmission; determining, by the server unit, that at least a portion of the personalization data is to be exchanged; and exchanging, by the server unit, the at least portion of the personalization data via a unicast transmission.

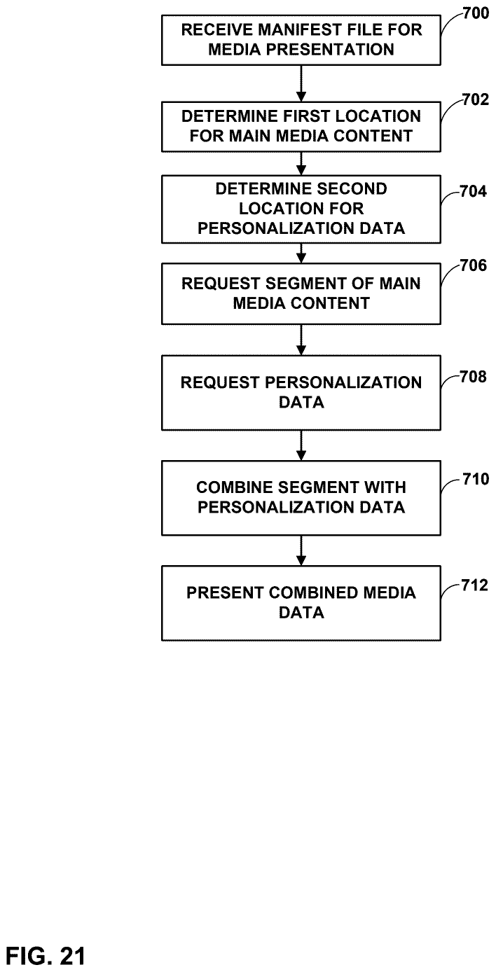

FIG. 21 is a flowchart illustrating an example method of retrieving media data by a client device per techniques of this disclosure. This method may be performed by a client device, such as client device 40, UE 200, or a media player client (e.g., DASH/HLS client 352, 452, 622, 652). In this example, the client device itself sends requests to different network locations for both broadcast/multicast content and unicast content.

Initially, in this example, the client device receives a manifest file for a media presentation (700), e.g., in response to a request for the manifest file. The client device processes the manifest file to determine a first network location for retrieving main media content (702). The manifest file includes a first set of data, such as a first base URL, representing this first network location, which corresponds to a server device (e.g., a local media server or proxy server that receives a broadcast distribution). The client device also determines a second, different network location for retrieving personalization data (704). The manifest file includes a second set of data, such as a second base URL, representing this second network location.

In some examples, the client device comprises a user equipment (UE) device communicatively coupled to a radio access network (RAN). In these examples, the second network location may correspond to a personalization data server included in the RAN.

The client device then requests at least one segment of the main media content from the server device at the first network location (706). The client device also requests at least a portion of the personalization data (e.g., a different media variant, a byte range, or ad content) from the second network location (708).

After receiving both the main media content and the personalization data, the client device combines the at least one segment of the main media content with the at least portion of the personalization data (710). For example, the client device may replace a byte range in the main media segment with a byte range received from the personalization data. The client device then presents the combined media data (712). This approach allows the client device to directly manage the hybrid retrieval of broadcast and unicast content.

In this manner, the method of FIG. 21 represents an example of a method of retrieving media data including: receiving, by a client device, a manifest file for a media presentation, the manifest file including a first set of data representing a first network location for retrieving main media content of the media presentation and a second set of data representing a second, different network location for retrieving personalization data for the media presentation, the first network location corresponding to a server device; requesting, by the client device, at least one segment of the main media content from the server device; requesting, by the client device, at least a portion of the personalization data from the second network location; and combining, by the client device, the at least one segment of the main media content with the at least portion of the personalization data.

Various examples of the techniques of this disclosure are summarized in the following clauses:

Clause 1: A method of retrieving media data, the method comprising: receiving, by a server unit for a client device, configuration data for a media streaming session for a media presentation to be received via broadcast or unicast, the configuration data indicating that personalization data for the media presentation can be selectively exchanged using a unicast transmission; determining, by the server unit, that at least a portion of the personalization data is to be exchanged; and exchanging, by the server unit, the at least portion of the personalization data via a unicast transmission.

Clause 2: The method of clause 1, wherein the at least portion of the personalization data includes watermarked data for the media presentation.

Clause 3: The method of any of clauses 1 and 2, wherein the at least portion of the personalization data includes common media client data (CMCD) for the media presentation.

Clause 4: A method of retrieving media data, the method comprising: receiving, by a server unit for a client device, a request for media data of a media presentation, the request including a request for main media content of the media presentation, the request further including data representing personalization data to be retrieved for the media presentation; receiving, by the server unit, the main media content via broadcast or multicast transmission; processing, by the server unit, the data representing the personalization data for the media presentation; retrieving, by the server unit, the personalization data; and sending, by the server unit, the main media content and the personalization data to a media player of the client device.

Clause 5: A method comprising a combination of the method of any of clauses 1-3 and the method of clause 4.

Clause 6: The method of any of clauses 4 and 5, wherein retrieving the personalization data comprises retrieving the personalization data via a unicast transmission.

Clause 7: The method of any of clauses 4 and 5, wherein retrieving the personalization data comprises receiving the personalization data as part of the broadcast or multicast transmission.

Clause 8: The method of any of clauses 4-7, further comprising receiving, from an application provider device, configuration information for processing requests including data representing personalization data.

Clause 9: The method of any of clauses 1-3 and 8, wherein receiving the configuration information comprises receiving a service announcement including the configuration information.

Clause 10: The method of any of clauses 4-9, wherein retrieving the personalization data comprises sending a second request comprising an HTTP Get or partial Get request.

Clause 11: The method of any of clauses 4-10, wherein the second request includes a header option field and a query option field.

Clause 12: The method of clause 11, wherein at least one of the header option field or the query option field includes the data representing the personalization data.

Clause 13: The method of any of clauses 4-12, wherein the personalization data includes common media client data (CMCD), the method further comprising sending the CMCD to an application provider device of a radio access network (RAN).

Clause 14: The method of any of clauses 4-13, wherein the personalization data includes watermark data corresponding to a watermark token.

Clause 15: The method of clause 14, wherein the watermark token indicates a variant pattern for the main media content and the personalization data, the main media content corresponding to a first variant, and the personalization data corresponding to a second, different variant.

Clause 16: The method of any of clauses 1-15, wherein the server unit comprises a proxy server included in a middleware unit of the client device.

Clause 17: The method of any of clauses 1-15, wherein the server unit comprises a server device separate from the client device.

Clause 18: A method of retrieving media data, the method comprising: receiving, by a client device, a manifest file for a media presentation, the manifest file including a first set of data representing a first network location for retrieving main media content of the media presentation and a second set of data representing a second, different network location for retrieving personalization data for the media presentation, the first network location corresponding to a server device; requesting, by the client device, at least one segment of the main media content from the server device; requesting, by the client device, at least a portion of the personalization data from the second network location; and combining, by the client device, the at least one segment of the main media content with the at least portion of the personalization data.

Clause 19: The method of clause 18, wherein the second network location corresponds to a personalization data server included in a radio access network (RAN), and wherein the client device comprises a user equipment (UE) device communicatively coupled to the RAN.

Clause 20: A device for retrieving media data, the device comprising one or more means for performing the method of any of clauses 1-19.

Clause 21: The device of clause 20, wherein the one or more means comprise a processing system implemented in circuitry.

Clause 22: The device of clause 20, wherein the apparatus comprises at least one of: an integrated circuit; a microprocessor; and a wireless communication device.

Clause 23: A computer-readable storage medium having stored thereon instructions that, when executed, cause a processing system to perform the method of any of clauses 1-19.

Clause 24: A server unit for sending and receiving media data, the server unit comprising: means for receiving, from a media application of a client device, configuration data for a media streaming session for a media presentation to be received via broadcast or unicast, the configuration data indicating that personalization data for the media presentation can be selectively exchanged using a unicast transmission; means for determining that at least a portion of the personalization data is to be exchanged; and means for exchanging the at least portion of the personalization data via a unicast transmission.

Clause 25: A server unit for sending and receiving media data, the server unit comprising: means for receiving, from a media application of a client device, a request for media data of a media presentation, the request including a request for main media content of the media presentation, the request further including data representing personalization data to be retrieved for the media presentation; means for receiving the main media content via broadcast or multicast transmission; means for processing the data representing the personalization data for the media presentation; means for retrieving the personalization data; and means for sending the main media content and the personalization data to the client device.

Clause 26: A client device for retrieving media data, the client device comprising: means for receiving a manifest file for a media presentation, the manifest file including a first set of data representing a first network location for retrieving main media content of the media presentation and a second set of data representing a second, different network location for retrieving personalization data for the media presentation, the first network location corresponding to a server device; means for requesting at least one segment of the main media content from the server device; means for requesting at least a portion of the personalization data from the second network location; and means for combining the at least one segment of the main media content with the at least portion of the personalization data.

Clause 27: A method of retrieving media data, the method comprising: receiving, by a server unit for a client device, configuration data for a media streaming session for a media presentation to be received via broadcast or unicast, the configuration data indicating that personalization data for the media presentation can be selectively exchanged using a unicast transmission; determining, by the server unit, that at least a portion of the personalization data is to be exchanged; and exchanging, by the server unit, the at least portion of the personalization data via a unicast transmission.

Clause 28: The method of clause 27, wherein the at least portion of the personalization data includes watermarked data for the media presentation, the watermarked data corresponding to a watermark token.

Clause 29: The method of clause 28, wherein the watermark token indicates a variant pattern for the main media content and the personalization data, the main media content corresponding to a first variant, and the personalization data corresponding to a second, different variant.

Clause 30: The method of any of clauses 27-29, wherein the at least portion of the personalization data includes common media client data (CMCD) for the media presentation.

Clause 31: The method of any of clauses 27-30, wherein receiving the configuration information comprises receiving the configuration information from an application provider device.

Clause 32: The method of any of clauses 27-31, wherein receiving the configuration information comprises receiving a service announcement including the configuration information.

Clause 33: The method of any of clauses 27-32, further comprising receiving, by the server unit, a request for media data of the media presentation from the client device, the request including a request for main media content of the media presentation, the request further including data representing the personalization data to be retrieved for the media presentation; receiving, by the server unit, the main media content via broadcast or multicast transmission; retrieving, by the server unit, the personalization data via the unicast transmission; and sending, by the server unit, the main media content and the personalization data to a media player of the client device.

Clause 34: The method of clause 33, wherein retrieving the personalization data comprises sending a second request comprising an HTTP GET or partial GET request.

Clause 35: The method of clause 34, wherein the second request includes a field including the data representing the personalization data, the field comprising one of a header option field or a query option field.

Clause 36: The method of any of clauses 27-35, wherein the personalization data includes common media client data (CMCD), the method further comprising sending the CMCD to an application provider device of a radio access network (RAN).

Clause 37: The method of any of clauses 27-36, wherein the server unit comprises a proxy server included in a middleware unit of the client device.

Clause 38: The method of any of clauses 27-36, wherein the server unit comprises a server device separate from the client device.

Clause 39: A server unit for retrieving media data on behalf of a client device, the server unit comprising: a memory configured to store media data; and a processing system implemented in circuitry and configured to: receive, for the client device, configuration data for a media streaming session for a media presentation to be received via broadcast or unicast, the configuration data indicating that personalization data for the media presentation can be selectively exchanged using a unicast transmission; determine that at least a portion of the personalization data is to be exchanged; and exchange the at least portion of the personalization data via a unicast transmission.

Clause 40: The server unit of clause 39, wherein the server unit comprises a proxy server included in a middleware unit of the client device.

Clause 41: The server unit of clause 39, wherein the server unit comprises a server device separate from the client device.

Clause 42: The server unit of any of clauses 39-41, wherein the at least portion of the personalization data includes watermarked data for the media presentation, the watermarked data corresponding to a watermark token.

Clause 43: The server unit of clause 42, wherein the watermark token indicates a variant pattern for the main media content and the personalization data, the main media content corresponding to a first variant, and the personalization data corresponding to a second, different variant.

Clause 44: The server unit of any of clauses 39-43, wherein the at least portion of the personalization data includes common media client data (CMCD) for the media presentation.

Clause 45: The server unit of any of clauses 39-44, wherein the processing system is further configured to: receive a request for media data of the media presentation from the client device, the request including a request for main media content of the media presentation, the request further including data representing the personalization data to be retrieved for the media presentation; receive the main media content via broadcast or multicast transmission; retrieve the personalization data via the unicast transmission; and send the main media content and the personalization data to a media player of the client device.

Clause 46: The server unit of clause 45, wherein to retrieve the personalization data, the processing system is configured to send a second request comprising an HTTP GET or partial GET request, the second request including a field including the data representing the personalization data, the field comprising one of a header option field or a query option field.

Clause 47: A method of retrieving media data, the method comprising: receiving, by a client device, a manifest file for a media presentation, the manifest file including a first set of data representing a first network location for retrieving main media content of the media presentation and a second set of data representing a second, different network location for retrieving personalization data for the media presentation, the first network location corresponding to a server device; requesting, by the client device, at least one segment of the main media content from the server device; requesting, by the client device, at least a portion of the personalization data from the second network location; and combining, by the client device, the at least one segment of the main media content with the at least portion of the personalization data.

Clause 48: The method of clause 47, wherein the second network location corresponds to a personalization data server included in a radio access network (RAN), and wherein the client device comprises a user equipment (UE) device communicatively coupled to the RAN.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of retrieving media data, the method comprising:
receiving, by a server unit for a client device, configuration data for a media streaming session for a media presentation to be received via broadcast or unicast, the configuration data indicating that personalization data for the media presentation can be selectively exchanged using a unicast transmission;
determining, by the server unit, that at least a portion of the personalization data is to be exchanged; and
exchanging, by the server unit, the at least portion of the personalization data via a unicast transmission.

2. The method of claim 1, wherein the at least portion of the personalization data includes watermarked data for the media presentation, the watermarked data corresponding to a watermark token.

3. The method of claim 2, wherein the watermark token indicates a variant pattern for main media content of the media presentation and the personalization data, the main media content corresponding to a first variant, and the personalization data corresponding to a second, different variant.

4. The method of claim 1, wherein the at least portion of the personalization data includes common media client data (CMCD) for the media presentation.

5. The method of claim 1, wherein receiving the configuration data comprises receiving the configuration data from an application provider device.

6. The method of claim 1, wherein receiving the configuration data comprises receiving a service announcement including the configuration data.

7. The method of claim 1, further comprising
receiving, by the server unit, a request for media data of the media presentation from the client device, the request including a request for main media content of the media presentation, the request further including data representing the personalization data to be retrieved for the media presentation;
receiving, by the server unit, main media content of the media presentation via broadcast or multicast transmission;
retrieving, by the server unit, the personalization data via the unicast transmission; and
sending, by the server unit, the main media content and the personalization data to a media player of the client device.

8. The method of claim 7, wherein retrieving the personalization data comprises sending a second request comprising an HTTP GET or partial GET request.

9. The method of claim 8, wherein the second request includes a field including the data representing the personalization data, the field comprising one of a header option field or a query option field.

10. The method of claim 1, wherein the personalization data includes common media client data (CMCD), the method further comprising sending the CMCD to an application provider device of a radio access network (RAN).

11. A server unit for retrieving media data on behalf of a client device, the server unit comprising:
a memory configured to store media data; and
a processing system implemented in circuitry and configured to:
receive, for the client device, configuration data for a media streaming session for a media presentation to be received via broadcast or unicast, the configuration data indicating that personalization data for the media presentation can be selectively exchanged using a unicast transmission;
determine that at least a portion of the personalization data is to be exchanged; and
exchange the at least portion of the personalization data via a unicast transmission.

12. The server unit of claim 11, wherein the server unit comprises a proxy server included in a middleware unit of the client device.

13. The server unit of claim 11, wherein the server unit comprises a server device separate from the client device.

14. The server unit of claim 11, wherein the at least portion of the personalization data includes watermarked data for the media presentation, the watermarked data corresponding to a watermark token.

15. The server unit of claim 14, wherein the watermark token indicates a variant pattern for main media content of the media presentation and the personalization data, the main media content corresponding to a first variant, and the personalization data corresponding to a second, different variant.

16. The server unit of claim 11, wherein the at least portion of the personalization data includes common media client data (CMCD) for the media presentation.

17. The server unit of claim 11, wherein the processing system is further configured to:
receive a request for media data of the media presentation from the client device, the request including a request for main media content of the media presentation, the request further including data representing the personalization data to be retrieved for the media presentation;
receive main media content of the media presentation via broadcast or multicast transmission;
retrieve the personalization data via the unicast transmission; and
send the main media content and the personalization data to a media player of the client device.

18. The server unit of claim 17, wherein to retrieve the personalization data, the processing system is configured to send a second request comprising an HTTP GET or partial GET request, the second request including a field including the data representing the personalization data, the field comprising one of a header option field or a query option field.

19. A method of retrieving media data, the method comprising:
receiving, by a client device, a manifest file for a media presentation, the manifest file including a first set of data representing a first network location for retrieving main media content of the media presentation and a second set of data representing a second, different network location for retrieving personalization data for the media presentation, the first network location corresponding to a server device;
requesting, by the client device, at least one segment of the main media content from the server device;
requesting, by the client device, at least a portion of the personalization data from the second network location; and
combining, by the client device, the at least one segment of the main media content with the at least portion of the personalization data.

20. The method of claim 19, wherein the second network location corresponds to a personalization data server included in a radio access network (RAN), and wherein the client device comprises a user equipment (UE) device communicatively coupled to the RAN.
